(19) United States
(12) Patent Application Publication
(10) Pub. No.: US 2023/0248024 A1
(43) Pub. Date: Aug. 10, 2023

(54) Pet Food Compositions

(71) Applicant: Hill's Pet Nutrition, Inc., Topeka, KS (US)

(72) Inventors: Dayakar BADRI, Lawrence, KS (US); Dennis JEWELL, Lawrence, KS (US); Kiran PANICKAR, Lawrence, KS (US)

(73) Assignee: Hill's Pet Nutrition, Inc., Topeka, KS (US)

(21) Appl. No.: 18/166,677

(22) Filed: Feb. 9, 2023

Related U.S. Application Data
(60) Provisional application No. 63/308,703, filed on Feb. 10, 2022.

(51) Int. Cl. A23K 10/30; A23K 50/42; A23K 20/158; A23K 20/147; A23K 10/20

(52) U.S. Cl. CPC A23K 10/30; A23K 50/42; A23K 20/158; A23K 20/147; A23K 10/20

(57) ABSTRACT

Pet food compositions as well as method for alleviating pruritus, erythema, alopecia, or skin and ear secretion are disclosed herein. The pet food composition may comprise from about 1 to about 10 wt. % of quinoa; from about 1 to about 10 wt. % of amaranth; and from about 0.5 to about 8 wt. % of egg shell membrane, wherein all weight percentages are based on the total weight of the pet food composition on a dry matter basis.

### CROSS-REFERENCE TO RELATED APPLICATION

This application claims the benefit of priority from U.S. Provisional Application No. 63/308,703, entitled “PET FOOD COMPOSITIONS” and filed Feb. 10, 2022, the contents of which is hereby incorporated herein in its entirety.

### BACKGROUND

Atopic dermatitis (AD) is a common type of chronic inflammatory skin disease found in pets. Canines particularly suffer from atopic dermatitis and one of the primary reasons for a veterinary visit. Typically, atopic dermatitis is characterized by pruritus (itchiness), erythema (redness), skin and ear secretions and alopecia (hair loss). Thus, atopic dermatitis is considered to significantly reduce the quality of life for pets suffering from atopic dermatitis.

In addition to a reduced quality of life, pets suffering from atopic dermatitis often suffer from pruritic skin disorder and/or skin membrane barrier dysfunction. Skin barrier plays a critical role in preventing the entry of allergens and microorganisms into the body. The physical skin barrier is localized in the uppermost area of the epidermis called stratum corneum. Further, the epidermis is continuously regenerated by terminally differentiating keratinocytes, a process called keratinization or cornification. Cornification begins with the migration of keratinocytes from the basal to upper layers during which keratinocytes also produce lipids and extrude them into the extracellular space to form extra-cellular enriched layers to maintain skin membrane barrier function. In addition, the presence of cytokines within the skin influences various processes of keratinocyte proliferation, differentiation and cornification.

It is believed that a combination of genetic, environmental, and immunological factors influence the pathogenesis of atopic dermatitis as well as the extent of the harm from such atopic dermatitis.

There is a present need for treatments, compositions, and methods for alleviating pets suffering from atopic dermatitis and the effects thereof.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

In accordance with an aspect of the invention, provided is a pet food composition that comprising from about 1 to about 10 wt. % of quinoa; from about 1 to about 10 wt. % of amaranth; and from about 0.5 to about 8 wt. % of egg shell membrane, wherein all weight percentages are based on the total weight of the pet food composition on a dry matter basis.

According to another aspect of the invention, provided is pet food composition including an alpha-amino acid, one or more ancient grain, egg shell membrane, from about 1 to about 8 wt. % of omega-3 fatty acid, and from about 1 to about 15 wt. % of omega-6 fatty acid, wherein the food composition has a weight ratio of omega-3 fatty acids to omega-6 fatty acids of from about 0.5:1 to about 7:1, and all weight percentages are based on the total weight of the pet food composition on a dry matter basis.

In accordance with a further aspect of the invention, provided is a pet food composition having a core and a coating disposed on the core. The core typically comprises amaranth and quinoa, while the coating comprising egg shell membrane. Additionally, the pet food composition has a macronutrient value comprising from about 2 to about 10 wt. % of dietary fiber, where the dietary fiber comprises from about 1 to about 9 wt. % of insoluble fiber, and from about 0.2 to about 4 wt. % of soluble fiber. The pet food composition also has a weight ratio of soluble fiber to insoluble fiber of from about 0.2:1 to about 10:1, and all weight percentages are based on the total weight of the pet food composition on a dry matter basis.

According to yet additional aspects of the invention, provided is a method for alleviating pruritus, erythema, alopecia, or skin and ear secretion in an atopic dermatitis canine. The method typically includes reducing metabolites and/or acylcarnitines that activate proinflammatory signaling pathways in a canine by feeding the canine a pet food composition disclosed herein.

In accordance with yet further aspects of the invention, provided is another method for alleviating pruritus, erythema, alopecia, or skin and ear secretion in an atopic dermatitis canine, where the method includes increasing one or more of long chain polyunsaturated fatty acid, nicotinamide, 1-methylnicotinamide, or a combination of two or more thereof in a canine by feeding the canine a pet food composition disclosed herein.

### BRIEF DESCRIPTION OF THE DRAWINGS

The features, and advantages of the invention will be apparent from the following more detailed description of certain embodiments of the invention and as illustrated in the accompanying drawings in which:

FIG. 1 is a bar graph of the improvement in pruritus for canines receiving a comparative composition or a non-liming exemplary composition in accordance with aspects of the invention;

FIG. 2A is a bar graph of the improvement in pruritus for canines receiving another non-limiting exemplary composition or a comparative composition according to aspects of the invention;

FIG. 2B is a bar graph of the improvement in erythema for canines receiving the exemplary composition or the comparative composition of FIG. 2A;

FIG. 2C is a bar graph of the improvement in alopecia for canines receiving the exemplary composition or the comparative composition of FIG. 2A;

FIG. 2D is a bar graph of the improvement in skin and ear secretions for canines receiving the exemplary composition or the comparative composition of FIG. 2A; and

FIG. 3 is a schematic showing a summary of the multifaceted benefits simultaneously achieved by the exemplary composition of FIGS. 2A-2D.

It should be understood that the various aspects are not limited to the compositions, arrangements, and instrumentality shown in the figures.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not necessarily limited in its application to the details of any particular embodiment disclosed. The terminology used herein is for the purpose of description and not of limitation.

As used herein and in the appended claims, the singular forms “a”, “an”, and “the” include plural references unless the context dictates otherwise. The singular form of any class of the ingredients refers not only to one ingredient within that class, but also to a mixture of those ingredients. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc. The term “about” when referring to a number means any number within a range of 10% of the number. For example, the phrase “about 2.0 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” means percent by weight with respect to the pet food composition. The symbol “°” refers to a degree, such as a temperature degree or a degree of an angle. The symbols “h”, “min”, “mL”, “nm”, “μm” means hour, minute, milliliter, nanometer, and micrometer, respectively. The abbreviation “UV-VIS” as referring to a spectrometer or spectroscopy, means Ultraviolet-Visible. The abbreviation “rpm” means revolutions per minute.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All components and elements positively set forth in this disclosure can be negatively excluded from the claims. In other words, the pet food compositions of the instant disclosure can be free or essentially free of all components and elements positively recited throughout the instant disclosure. In some instances, the pet food compositions of the present disclosure may be substantially free of non-incidental amounts of the ingredient(s) or compound(s) described herein. A non-incidental amount of an ingredient or compound is the amount of that ingredient or compound that is added into the pet food composition by itself. For example, a pet food composition may be substantially free of a non-incidental amount of an ingredient or compound, although such ingredient(s) or compound(s) may be present as part of a raw material that is included as a blend of two or more compounds.

Some of the various categories of components identified may overlap. In such cases where overlap may exist and the pet food composition includes both components (or the composition includes more than two components that overlap), an overlapping compound does not represent more than one component. For example, certain components or ingredients may be characterized as both an ancient grain and an amaranth. If a particular pet food care composition recites both an ancient grain and an amaranth, a compound that may be characterized as both an ancient and an amaranth will serve only as either an ancient or an amaranth—not both.

As used herein, the term “pet” could be used interchangeably with “companion animal” and refers to an animal of any species kept by a caregiver as a pet or any animal of a variety of species that have been widely domesticated as pets, including canines (Canis familiaris) and felines (Fells domesticus). Thus, a pet may include but is not limited to, working dogs, pet dogs, cats kept for rodent control (i.e. farm cats), pet cats, ferrets, birds, reptiles, rabbits, and fish.

To the extent that food and food ingredient contain water/moisture, the dry matter represents everything in the sample other than water including, for example, protein, fiber, fat, carbohydrates, minerals, etc. Dry matter weight is the total weight minus the weight of any water. The skilled artisan would readily recognize and understand nutritional amounts and percentages expressed as dry matter amounts, dry matter weights and dry matter percentages.

Dry matter intake per day is calculated as the total nutritional intake per day excluding all water. For example, an amount of an ingredient equal to a specific percent of daily nutritional intake refers to the amount of that ingredient in dry matter form (i.e., excluding all water) relative to the total amount of dry matter consumed (also excluding all water) in a day.

“Daily nutritional intake” and “total nutritional intake per day” refer to dry matter intake per day. That is, water weight is not included in calculating the amount of nutrition consumed per day. To calculate percent of an ingredient of total daily intake on a dry matter basis, water is removed from the total intake to give total daily dry matter intake and the percent of the ingredient is based on amount of ingredient present as dry matter.

As used herein, an “ingredient” refers to any component of a pet food composition. The term “nutrient” refers to a substance that provides nourishment and thus has a nutrient value. In some cases, an ingredient may comprise more than one “nutrient,” for example, a composition may comprise corn comprising important nutrients including both protein and carbohydrate.

Aspects of the invention are directed pet food composition as well as methods for alleviating pruritus, erythema, alopecia, or skin and ear secretion. The inventors discovered that pet food compositions having certain combinations of ingredients in particular ratios provide significant health improvements for pets receiving such food compositions. For instance, certain pet food compositions disclosed herein can yield a significant reduction in atopic dermatitis in pets suffering from pruritus, erythema, alopecia, and/or skin and ear secretion. Without being particularly limited to any specific theory, the inventors believe that certain pet food compositions disclosed herein achieve the significant improvements in skin health for pets suffering from pruritus, erythema, alopecia, or skin and ear secretion, surprisingly, by improving the health of the pets gut (e.g., improving the microbiome in the pet's intestines).

The pet food compositions according to certain embodiments of the invention include from about 0.1 to about 5 wt. % of an alpha-amino acid; from about 1 to about 15 wt. % of one or more ancient grains (e.g., about 1 to about 10 wt. % of quinoa and about 1 to about 10 wt. % of amaranth); and from about 0.5 to about 8 wt. % of egg shell membrane, wherein all weight percentages are based on the total weight of the pet food composition on a dry matter basis. The pet food compositions may, in some embodiments, include one or more fatty acid, such as a polyunsaturated fatty acid. For example, the pet food composition may include a polyunsaturated fatty acid(s) selected from omega-3 fatty acid, an omega-6 fatty acid, or a combination of two or more thereof. The pet food compositions may be formulated to have omega-3 fatty acid(s) and an omega-6 fatty acid(s), preferably in a weight ratio of from about 0.5:1 to about 7:1. In some embodiments, the pet food compositions may be formulated to control the weight ratio of linolenic acid to arachidonic acid of from about 12:1 to about 50:1.

The pet food composition may also have a macronutrient value comprising from about 2 to about 10 wt. % of dietary fiber, where the dietary fiber comprises from about 1 to 9 wt. % of insoluble fiber, and from about 0.5 to 4 wt. % of soluble fiber. Additionally, the pet food composition may have a weight ratio of soluble fiber to insoluble fiber of from about 0.2:1 to about 10:1, where all weight percentages are based on the total weight of the pet food composition on a dry matter basis.

In accordance with further embodiments, the pet food composition is a pet food composition is in a form having a core and a coating disposed on the core. The core typically comprises lysine and amaranth, while the coating comprising egg shell membrane. Without being limited to any particular theory, it is believed that including the eggshell membrane in the coating may maintain higher concentrations of the bioactive peptides in the egg shell membrane.

Suitable components, such as those listed below, may be included or excluded from the formulations for the pet food compositions depending on the specific combination of other ingredients and the form of the pet food compositions. In some embodiments, the pet food compositions disclosed herein may be in the form of a stand-alone pet food, as a supplement to pet food, as a pet food treat, or the like.

The pet food compositions typically include one or more ancient grain. As used herein, an ancient grain refers to wheats, such as spelt, Khorasan wheat (Kamut), einkorn, and emmer; grains, such as millet, barley, teff, oats, and sorghum; and pseudocereals such as, amaranth, quinoa, buckwheat, and chia. In some embodiments, the pet food composition comprises two or more ancient grains, three or more ancient grains, four or more ancient grains, or five or more ancient grains. The ancient grains may be selected in some cases from millet, barley, teff, oats, sorghum, amaranth, buckwheat, chia, and a combination of two or more thereof. Preferably, the ancient grains are selected from quinoa, amaranth, buckwheat, bulgar, sorghum, and a combination of two or more thereof. In some cases, the pet food composition may include at least two ancient grains selected from quinoa, amaranth, buckwheat, bulgar, sorghum, and a combination of two or more thereof. For example, the pet food composition may comprise quinoa and an amaranth.

Additionally or alternatively, the pet food composition may comprise a first ancient grain (e.g., quinoa) and a second ancient grain (e.g., amaranth) in a weight ratio of from about 1:12 to about 12:1. In some instances, the pet food composition has a weight ratio of a first ancient grain to second ancient grain of from about 1:10 to about 10:1, from about 1:8 to about 8:1, from about 1:7 to about 7:1, from about 1:6 to about 6:1, from about 1:5 to about 5:1, from about 1:4 to about 4:1, from about 1:3 to about 3:1, or from about 1:2 to about 2:1, or any range or subrange thereof. In at least one embodiment, the weight ratio of the first ancient grain (e.g., quinoa) to the second ancient grain (e.g., amaranth) is about 1:1 or is 1:1.

The one or more ancient grain may be included in the pet food compositions in an amount ranging from about 1 to about 15 wt. %, based on the total weight of the pet food composition on a dry matter basis. For example, the one or more ancient grain may be present in an amount of from about 1 to about 15 wt. %, about 1 to about 12 wt. %, about 1 to about 10 wt. %, about 1 to about 8 wt. %, about 1 to about 6 wt. %, about 1 to about 4 wt. %, about 1 to about 3 wt. %; from about 2 to about 15 wt. %, about 2 to about 12 wt. %, about 2 to about 10 wt. %, about 2 to about 8 wt. %, about 2 to about 6 wt. %, about 2 to about 4 wt. %, about 2 to about 3 wt. %; from about 3 to about 15 wt. %, about 3 to about 12 wt. %, about 3 to about 10 wt. %, about 3 to about 8 wt. %, about 3 to about 6 wt. %, about 3 to about 4 wt. %; from about 4 to about 15 wt. %, about 4 to about 12 wt. %, about 4 to about 10 wt. %, about 4 to about 8 wt. %, or about 4 to about 6 wt. %, including ranges and subranges thereof, based on the total weight of the pet food composition on a dry matter basis. In at least one embodiment, the pet food composition includes about 2.5 wt. % or 2.5 wt. % of a first ancient grain, such as quinoa, based on the total weight of the pet food composition on a dry matter basis. Additionally or alternatively, the pet food composition may include about 2.5 wt. % or 2.5 wt. % of a second ancient grain, such as an amaranth, based on the total weight of the pet food composition on a dry matter basis.

The pet food composition typically includes egg shell membrane. Egg shell membrane typically includes a protein component, hyaluronic acid, and certain bioactive peptides that may be beneficial in the pet food compositions disclosed herein. Without being limited to any particular theory, it is believed that pet food compositions containing egg shell membrane instead of egg or dried egg, significantly reduces allergic reactions of pets suffering from egg allergies. The egg shell membrane may be present in the pet food composition in an amount ranging from about 0.5 to about 8 wt. %, based on the total weight of the pet food composition on a dry matter basis. For instance, the pet food composition may include an amount of egg shell membrane from about 0.5 to about 8 wt. %, about 0.5 to about 7 wt. %, about 0.5 to about 6 wt. %, about 0.5 to about 5 wt. %, about 0.5 to about 4 wt. %, about 0.5 to about 3 wt. %, about 0.5 to about 2 wt. %; from about 1 to about 8 wt. %, about 1 to about 7 wt. %, about 1 to about 6 wt. %, about 1 to about 5 wt. %, about 1 to about 4 wt. %, about 1 to about 3 wt. %, about 1 to about 2 wt. %; from about 2 to about 8 wt. %, about 2 to about 7 wt. %, about 2 to about 6 wt. %, about 2 to about 5 wt. %, about 2 to about 4 wt. %, about 2 to about 3 wt. %; from about 3 to about 8 wt. %, about 3 to about 7 wt. %, about 3 to about 6 wt. %, about 3 to about 5 wt. %, or about 3 to about 4 wt. %, including ranges and subranges thereof, based on the total weight of the pet food composition on a dry matter basis. In at least one embodiment, the pet food composition includes about 2 wt. % or 2 wt. % of egg shell membrane, based on the total weight of the pet food composition on a dry matter basis.

In some embodiments, the pet food composition is formulated to have certain weight ratios of the ancient grain(s) to the egg shell membrane. For example, the pet food composition may have a weight ratio of ancient grain(s) to egg shell membrane of from about 1:10 to about 24:1, from about 1:8 to about 20:1, from about 1:6 to about 16:1, from about 1:5 to about 14:1, from about 1:4 to about 12:1, from about 1:3 to about 10:1, from about 1:2 to about 8:1, from about 1:1 to about 6:1, from about 1:1 to about 4:1 or any ranges or subranges thereof. In at least one embodiment, the pet food composition has at least two ancient grains with a weight ratio of a first ancient grain (e.g., quinoa) to egg shell membrane of from about 1:10 to about 12:1, from about 1:8 to about 10:1, from about 1:6 to about 8:1, from about 1:5 to about 7:1, from about 1:4 to about 6:1, from about 1:3 to about 5:1, from about 1:2 to about 4:1, from about 1:1 to about 6:1, from about 1:1 to about 5:1, from about 1:1 to about 4:1, from about 1:1 to about 3:1, from about 1:1 to about 2:1, or any ranges or subranges thereof. Additionally or alternatively, the pet food composition may have a weight ratio of a second ancient grain (e.g., amaranth) to egg shell membrane of from about 1:10 to about 12:1, from about 1:8 to about 10:1, from about 1:6 to about 8:1, from about 1:5 to about 7:1, from about 1:4 to about 6:1, from about 1:3 to about 5:1, from about 1:2 to about 4:1, from about 1:1 to about 6:1, from about 1:1 to about 5:1, from about 1:1 to about 4:1, from about 1:1 to about 3:1, from about 1:1 to about 2:1, or any ranges or subranges thereof.

The pet food composition, in some cases, preferably is formulated to have certain weight ratios of quinoa to amaranth to egg shell membrane (quinoa:amaranth:egg shell membrane) of from about 1:10:8 to about 10:10:1. For example, the weight ratio of quinoa to amaranth to egg shell membrane may be from about 1:10:8 to about 10:10:1, about 1:5:4 to about 5:5:1, about 1:8:4 to about 10:2:4, about 1:4:2 to about 5:1:2, or any ranges or subranges thereof.

Optionally, the pet food composition may include one or more an alpha-amino acid. The alpha-amino acid may contain an alpha-carboxylic acid group. In some embodiments, the one or more alpha-amino acid comprises lysine. The alpha-amino acid may be present in the food composition in an amount ranging from about 0.1 to about 5 wt. %, based on the total weight of the pet food composition on a dry matter basis. For example, pet food composition may include one or more alpha-amino acid in an amount of from about 0.1 to about 5 wt. %, about 0.1 to about 4 wt. %, about 0.1 to about 3 wt. %, about 0.1 to about 2 wt. %, about 0.1 to about 1 wt. %; from about 0.2 to about 5 wt. %, about 0.2 to about 4 wt. %, about 0.2 to about 3 wt. %, about 0.2 to about 2 wt. %, about 0.2 to about 1 wt. %; from about 0.5 to about 5 wt. %, about 0.5 to about 4 wt. %, about 0.5 to about 3 wt. %, about 0.5 to about 2 wt. %, about 0.5 to about 1 wt. %; from about 0.75 to about 5 wt. %, about 0.75 to about 4 wt. %, about 0.75 to about 3 wt. %, about 0.75 to about 2 wt. %, about 0.75 to about 1 wt. %; from about 1 to about 5 wt. %, about 1 to about 4 wt. %, about 1 to about 3 wt. %, about 1 to about 2 wt. %; from about 2 to about 5 wt. %, about 2 to about 4 wt. %, about 2 to about 3 wt. %; from about 3 to about 5 wt. %, about 3 to about 4 wt. %, or any range or subrange thereof, based on the total weight of the pet food composition on a dry matter basis. In at least one embodiment, the pet food composition includes an alpha-amino acid, preferably lysine, in an amount of about 2.5 wt. % or 2.5 wt. %, based on the total weight of the pet food composition on a dry matter basis.

Additional ingredients may be included, or in some instances excluded, include beef broth, brewers dried yeast, egg, egg product, flax meal, DL methionine, amino acids, leucine, lysine, arginine, cysteine, cystine, aspartic acid, polyphosphates, sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, Lcarnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), antifoaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, and/or keratolytics.

Additionally or alternatively, the pet food compositions may be formulated to have a certain macronutrient value(s). As noted above, the inventors discovered that formulating pet food compositions to have certain nutrients in particular weight ratios enhance the pet food compositions reduction in atopic dermatitis in canines suffering pruritus, erythema, alopecia, or skin and ear secretion from pets suffering therefrom.

The pet food compositions are typically formulated so as to have one or more fatty acid(s). Non-limiting examples of fatty acids include, but are not limited to, omega-3 fatty acids, omega-6 fatty acids, lauric acid, myristic acid, palmitic acid, palmitoleic acid, margaric acid, margaroleic acid, stearic acid, oleic acid, stearidonic acid, gadoleic acid, behenic acid, erucic acid, docosatetra acid, and a combination of two or more thereof. The fatty acid(s) may be a polyunsaturated fatty acid, such as an omega-3 fatty acid, an omega-6 fatty acid, or a combination of two or more thereof. Non-limiting examples of omega-3 fatty acids include those selected from linolenic acid, stearidonic acid, eicosatetraenoic acid, eicosapentaenoic acid, docosapentaenoic acid, docosahexaenoic acid, and a combination of two or more thereof. The pet food composition may include linolenic acid, eicosapentaenoic acid, docosahexaenoic acid, or a combination of two or more thereof. In at least one embodiment, the pet food composition comprises alpha-linolenic acid and/or gamma-linolenic acid. In further embodiments, the pet food composition includes one or more omega-3 fatty acid(s) comprising eicosapentaenoic acid, docosahexaenoic acid, or a combination thereof.

Additionally or alternatively, the polyunsaturated fatty acid may comprise an omega-6 fatty acids. Examples of omega-6 fatty acid include linolenic acid, calendic acid, eicosadienoic acid, arachidonic acid, docosadienoic acid, adrenic acid, osbond acid, tetracosatetraenoic acid, tetracosapentaenoic acid, or a combination of two or more thereof. In some embodiments, the polyunsaturated fatty acid comprises an omega-6 fatty acid selected from linolenic acid, arachidonic acid, and a combination of two or more thereof. In at least one preferable embodiment, the pet food composition is formulated to have a weight ratio of linolenic acid to arachidonic acid of from about 12:1 to about 50:1. In some instances, the weight ratio of linolenic acid to arachidonic acid is about 15:1 to about 40:1, about 15:1 to about 35:1, about 15:1 to about 30:1, about 15:1 to about 28:1; from about 18:1 to about 40:1, about 18:1 to about 35:1, about 18:1 to about 30:1, about 18:1 to about 28:1; from about 20:1 to about 40:1, about 20:1 to about 35:1, about 20:1 to about 30:1, about 20:1 to about 28:1; from about 22:1 to about 40:1, about 22:1 to about 35:1, about 22:1 to about 30:1, about 2:1 to about 28:1; from about 18:1 to about 35:1, about 20:1 to about 30:1, about 22:1 to about 28:1, or any range or subrange thereof.

Additionally or alternatively, the pet food composition may be formulated to have a weight ratio of omega-3 fatty acids to omega-6 fatty acids of from about 0.5:1 to about 7:1. In some embodiments, the pet food composition has a weight ratio of omega-3 fatty acids to omega-6 fatty acids of from about 0.5:1 to about 6:1, about 0.5:1 to about 5:1, about 0.5:1 to about 4:1, about 0.5:1 to about 3:1, about 0.5:1 to about 2.5:1, about 0.5:1 to about 2:1, about 0.5:1 to about 1.5:1, or about 0.5:1 to about 1:1; from about 1:1 to about 6:1, about 1:1 to about 5:1, about 1:1 to about 4:1, about 1:1 to about 3:1, about 1:1 to about 2.5:1, about 1:1 to about 2:1, about 1:1 to about 1.5:1, or about 1:1 to about 1:1, including ranges or subranges thereof.

In some embodiments, the food composition further comprises one or more amino acids. The one or more amino acid(s) may be included in the pet food compositions as free amino acids, or supplied by any number of sources, e.g., crude protein, to the compositions of the present disclosure. Examples of amino acids may include, but are not limited to, Tryptophan, Taurine, Histidine, Carnitine, Carnosine, Alanine, Cysteine, Arginine, Methionine (including DL-methionine, and L-methionine), Tryptophan, Lysine, Asparagine, Aspartate (Aspartic acid), Phenylalanine, Valine, Threonine, Isoleucine, Histidine, Leucine, Glycine, Glutamine, Taurine, Tyrosine, Homocysteine, Ornithine, Citruline, Glutamate (Glutamic acid), Proline, and/or Serine.

The one or more amino acid(s) may comprise essential amino acids. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

The pet food composition comprise a total dietary fiber typically in amount ranging from about 2 to about 20 wt. %, based on the total weight of the pet food composition on a dry matter basis. For example, the total dietary fiber may be present in an amount of from about 2 to about 20 wt. %, about 2 to about 16 wt. %, about 2 to about 12 wt. %, about 2 to about 10 wt. %, about 2 to about 8 wt. %, about 2 to about 6 wt. %; from about 6 to about 20 wt. %, about 6 to about 16 wt. %, about 6 to about 12 wt. %, about 6 to about 10 wt. %; from about 8 to about 20 wt. %, about 8 to about 16 wt. %, about 8 to about 12 wt. %, about 8 to about 10 wt. %; from about 10 to about 20 wt. %, about 10 to about 16 wt. %; from about 12 to about 20 wt. %, about 12 to about 16 wt. %; from about 14 to about 20 wt. %, or about 14 to about 16 wt. %, including ranges and subranges thereof, based on the total weight of the pet food composition on a dry matter basis.

Dietary fiber refers to components of a plant which are resistant to digestion by an animal's digestive enzymes. Dietary fiber includes soluble fiber and insoluble fiber. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole-wheat products, wheat oat, corn bran, flax seed, grapes, celery, green beans, cauliflower, potato skins, fruit skins, vegetable skins, peanut hulls, and soy fiber. Crude fiber includes indigestible components contained in cell walls and cell contents of plants such as grains, for example, hulls of grains such as rice, corn, and beans. Typical crude fiber amounts in compositions of the present disclosure can be from about 0 to about 20 wt. %, about 1 to about 20 wt. %, about 1 to about 15 wt. %, about 1 to about 10 wt. %, about 1 to about 7 wt. %, about 1 to about 5 wt. %, about 1 to about 3 wt. %; from about 3 to about 20 wt. %, about 3 to about 15 wt. %, about 3 to about 10 wt. %, about 3 to about 7 wt. %, about 3 to about 5 wt. %; from about 5 to about 20 wt. %, about 5 to about 15 wt. %, about 5 to about 10 wt. %, about 5 to about 7 wt. %; from about 7 to about 20 wt. %, about 7 to about 15 wt. %, or about 7 to about 10 wt. %, including any ranges or subranges thereof, based on the total weight of the pet food composition on a dry matter basis.

The pet food composition may include from about 1 to about 9 wt. % of insoluble fiber, based on the total weight of the pet food composition on a dry matter basis. For example, the amount of insoluble fiber present in the pet food composition may be from about 1 to about 9 wt. %, about 1 to about 8 wt. %, about 1 to about 7 wt. %, about 1 to about 6 wt. %, about 1 to about 5 wt. %, about 1 to about 4 wt. %, about 1 to about 3 wt. %; from about 2 to about 9 wt. %, about 2 to about 8 wt. %, about 2 to about 7 wt. %, about 2 to about 6 wt. %, about 2 to about 5 wt. %, about 2 to about 4 wt. %; from about 3 to about 9 wt. %, about 3 to about 8 wt. %, about 3 to about 7 wt. %, about 3 to about 6 wt. %, about 3 to about 5 wt. %; from about 4 to about 9 wt. %, about 4 to about 8 wt. %, about 4 to about 7 wt. %, or about 4 to about 6 wt. %, including ranges and subranges thereof, based on the total weight of the pet food composition on a dry matter basis.

The pet food composition may include from about 0.2 to about 4 wt. % of soluble fiber, based on the total weight of the pet food composition on a dry matter basis. For example, amount of soluble fiber present in the pet food composition may be from about 0.2 to about 4 wt. %, about 0.2 to about 3 wt. %, about 0.2 to about 2 wt. %, about 0.2 to about 1 wt. %; from about 0.5 to about 4 wt. %, about 0.5 to about 3 wt. %, about 0.5 to about 2 wt. %, about 0.5 to about 1 wt. %; from about 0.75 to about 4 wt. %, about 0.75 to about 3 wt. %, about 0.75 to about 2 wt. %; from about 1 to about 4 wt. %, about 1 to about 3 wt. %, about 1 to about 2 wt. %; from about 2 to about 4 wt. %, or about 2 to about 3 wt. %, including ranges and subranges thereof, based on the total weight of the pet food composition on a dry matter basis.

The pet food composition may be formulated to have a weight ratio of soluble fiber to insoluble fiber of from about 0.2:1 to about 10:1. For example, the pet food composition may have a weight ratio of soluble fiber to insoluble fiber of from about 0.2:1 to about 10:1, about 0.2:1 to about 8:1, about 0.2:1 to about 6:1, or about 0.2:1 to about 4:1. In some cases, the pet food composition may have a weight ratio of soluble fiber to insoluble fiber of from about 0.5:1 to about 10:1, about 0.5:1 to about 8:1, about 0.5:1 to about 6:1, or about 0.5:1 to about 4:1. In further instances, the pet food composition may have a weight ratio of soluble fiber to insoluble fiber of about 1:1 to about 10:1, about 1:1 to about 8:1, about 1:1 to about 6:1, or about 1:1 to about 4:1. In at least one instance, the pet food composition has a weight ratio of soluble fiber to insoluble fiber of about 2:1 to about 10:1, about 2:1 to about 8:1, about 2:1 to about 6:1, or about 2:1 to about 4:1.

The pet food composition typically comprise protein and/or a digestible crude protein. The term “protein” means a polypeptide, or a peptide, or a polymer of amino acids. The term encompasses naturally occurring and non-naturally occurring (synthetic) polymers and polymers in which artificial chemical mimetics are substituted for one or more amino acids. The term also encompasses fragments, variants, and homologs that have the same or substantially the same properties and perform the same or substantially the same function as the original sequence. The term encompasses polymers of any length, including polymers containing from about 2 to 1000, from 4 to 800, from 6 to 600, and from 8 to 400 amino acids. The protein may include amino acid polymers that are synthesized and that are isolated and purified from natural sources. Under some embodiments, the terms “polypeptide”, “peptide” or “protein” are used interchangeably.

“Digestible crude protein” is the portion of protein that is available or can be converted into free nitrogen (amino acids) after digesting with gastric enzymes. In vitro measurement of digestible crude protein may be accomplished by using gastric enzymes such as pepsin and digesting a sample and measuring the free amino acid after digestion. In vivo measurement of digestible crude protein may be accomplished by measuring the protein levels in a feed/food sample and feeding the sample to an animal and measuring the amount of nitrogen collected in the animal's feces.

The protein and/or digestible crude protein of the composition may be present at various amounts or concentrations. In one embodiment, protein may be present in an amount of from about 10 to about 40 wt. %, based on the total weight of the pet food composition on a dry matter basis. For example, protein may be present in an amount of from about 10 to about 40 wt. %, about 10 to about 36 wt. %, about 10 to about 32 wt. %, about 10 to about 28 wt. %, about 10 to about 24 wt. %, about 10 to about 20 wt. %, about 10 to about 18 wt. %; from about 12 to about 40 wt. %, about 12 to about 36 wt. %, about 12 to about 32 wt. %, about 12 to about 28 wt. %, about 12 to about 24 wt. %, about 12 to about 20 wt. %, about 12 to about 18 wt. %; from about 14 to about 40 wt. %, about 14 to about 36 wt. %, about 14 to about 32 wt. %, about 14 to about 28 wt. %, about 14 to about 24 wt. %, about 14 to about 20 wt. %, about 14 to about 18 wt. %; from about 16 to about 40 wt. %, about 16 to about 36 wt. %, about 16 to about 32 wt. %, about 16 to about 28 wt. %, about 16 to about 24 wt. %, about 16 to about 20 wt. %, or about 16 to about 18 wt. %, including ranges or subranges thereof, based on the total weight of the pet food composition on a dry matter basis. In some embodiments, the pet food composition includes protein in amount of about 10 wt. %, about 15 wt. %, about 20 wt. %, about 25 wt. %, about 30 wt. %, about 35 wt. %, about 40 wt. %, or any range formed therefrom, based on the total weight of the pet food composition on a dry matter basis. In another example, protein may be present in an amount of from about 10 to about 25 wt. %, about 15 to about 25 wt. %, or about 15 to about 20 wt. %, based on the total weight of the pet food composition on a dry matter basis on a dry matter basis. In certain embodiments, protein is present in an amount of about 12 to about 35 wt. %, about 13 to about 25 wt. %, or about 15 to about 25 wt. %, based on the total weight of the pet food composition on a dry matter basis.

A portion of the protein in the composition may be digestible protein. For example, the composition may include an amount of protein, where about 40 wt. % or more, about 50 wt. % or more, about 60 wt. % or more, about 70 wt. % or more, about 80 wt. % or more, about 90 wt. % or more, about 95 wt. % or more, about 98 wt. % or more, or about 99 wt. % or more of the protein is digestible protein. In some embodiments, e.g., when the composition desirable promotes weight loss, the portion of protein that is digestible protein is about 60 wt. % or less, about 50 wt. % or less, about 40 wt. % or less, about 30 wt. % or less, about 20 wt. % or less, or about 10 wt. % or less, based on the total amount of protein in the pet food composition on a dry matter basis. In further embodiment, the amount of protein that is digestible protein is about 10 to about 99 wt. %, about 10 to about 95 wt. %, about 10 to about 90 wt. %, about 10 to about 70 wt. %, about 10 to about 50 wt. %, about 10 to about 30 wt. %; about 30 to about 99 wt. %, about 30 to about 95 wt. %, about 30 to about 90 wt. %, about 30 to about 70 wt. %, about 30 to about 50 wt. %; about 50 to about 99 wt. %, about 50 to about 95 wt. %, about 50 to about 90 wt. %, about 50 to about 70 wt. %; or about 70 to about 99 wt. %, about 70 to about 95 wt. %, about 70 to about 90 wt. %, including ranges and subranges therein, based on the total amount of protein in the pet food composition on a dry matter basis.

Protein may be supplied by any of a variety of sources known by those of ordinary skill in the art including plant sources, animal sources, microbial sources or a combination of these. For example, animal sources may include meat, meat-by products, seafood, dairy, eggs, etc. Meats, for example, may include animal flesh such as poultry, fish, and mammals including cattle, pigs, sheep, goats, and the like. Meat by-products may include, for example, lungs, kidneys, brain, livers, stomachs and intestines. Plant protein includes, for example, soybean, cottonseed, and peanuts. Microbial sources may be used to synthesize amino acids (e.g., lysine, threonine, tryptophan, methionine) or intact protein such as protein from sources listed below.

Examples of protein or protein ingredients may comprise chicken meals, chicken, chicken by-product meals, lamb, lamb meals, turkey, turkey meals, beef, beef by-products, viscera, fish meal, enterals, kangaroo, white fish, venison, soybean meal, soy protein isolate, soy protein concentrate, corn gluten meal, corn protein concentrate, distillers dried grains, and/or distillers dried grain solubles and single-cell proteins, for example yeast, algae, and/or bacteria cultures.

The protein can be intact, completely hydrolyzed, or partially hydrolyzed. The protein content of foods may be determined by any number of methods known by those of skill in the art, for example, as published by the Association of Official Analytical Chemists in Official Methods of Analysis (“OMA”), method 988.05. The amount of protein in a composition disclosed herein may be determined based on the amount of nitrogen in the composition according to methods familiar to one of skill in the art.

The compositions of the present invention may optionally comprise fat. The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure. The fat may be incorporated completely within the food composition, deposited on the outside of the pet food composition, or a mixture of the two methods. In some embodiments, the pet food compositions further include an effective amount of one or more substances selected from the group consisting of glucosamine, chondroitin, chondroitin sulfate, methylsulfonylmethane (“MSM”), creatine, antioxidants, Perna canaliculata, and mixtures thereof.

Fat can be supplied by any of a variety of sources known by those skilled in the art, including meat, meat by-products, canola oil, fish oil such as anchovy oil and menhaden oil, and plants. Meat fat sources include poultry fat, turkey fat, pork fat, lard, tallow, and beef fat. Plant fat sources include wheat, flaxseed, rye, barley, rice, sorghum, corn, oats, millet, wheat germ, corn germ, soybeans, peanuts, and cottonseed, as well as oils derived from these and other plant fat sources such as corn oil, soybean oil, cottonseed oil, palm oil, palm kernel oil, linseed oil, canola oil, rapeseed oil, and/or olestra.

The compositions of the present disclosure may contain about 9 wt. % or more (e.g., from about 9 to about 30 wt. %, or from about 10 to about 20 wt. %, or from about 10 to about 15 wt. %) of total fat, based on the total weight of the pet food composition on a dry matter basis. For example, the amount of fat present in the pet food composition may be from about 9 to about 30 wt. %, about 9 to about 26 wt. %, about 9 to about 22 wt. %, about 9 to about 18 wt. %, about 9 to about 16 wt. %, about 9 to about 14 wt. %; from about 11 to about 30 wt. %, about 11 to about 26 wt. %, about 11 to about 22 wt. %, about 11 to about 18 wt. %, about 11 to about 16 wt. %, about 11 to about 14 wt. %; from about 12 to about 30 wt. %, about 12 to about 26 wt. %, about 12 to about 22 wt. %, about 12 to about 18 wt. %, about 12 to about 16 wt. %, or about 12 to about 14 wt. %, including ranges and subranges thereof, based on the total weight of the pet food composition on a dry matter basis.

In some cases, the fat in the compositions is crude fat. Crude fat may be included into the compositions in the amounts disclose above with respect of the total fat, such as from about 9 to about 40 wt. %, based on the total weight of the pet food composition on a dry matter basis. In some embodiments, the pet food composition comprises crude fat in an amount of about 10 to about 20 wt. %, about 10 to about 18 wt. %, about 10 to about 16 wt. %; about 12 to about 20 wt. %, about 12 to about 18 wt. %, or about 12 to about 16 wt. %, based on the total weight of the pet food composition on a dry matter basis. In some cases, it may be preferable that about 50 wt. % or more, about 60 wt. % or more, about 70 wt. % or more, about 80 wt. % or more, or about 90 wt. % or more of the total fat is obtained from an animal source. Alternatively, about 50 wt. % or more, about 60 wt. % or more, about 70 wt. % or more, about 80 wt. % or more, or about 90 wt. % or more of the total fat may be obtained from a plant source.

The term “carbohydrate” as used herein includes polysaccharides (e.g., starches and dextrins) and sugars (e.g., sucrose, lactose, maltose, glucose, and fructose) that are metabolized for energy when hydrolyzed. One skilled in the art could manipulate the texture of the final product by properly balancing carbohydrate sources. For example, short chain polysaccharides lend to be sticky and gluey, and longer chain polysaccharides are less sticky and gluey than the shorter chain; the desired texture of this hybrid food is achieved by longer chain polysaccharide and modified starches such as native or modified starches, cellulose and the like. The carbohydrate mixture may additionally comprise optional components such as added salt, spices, seasonings, vitamins, minerals, flavorants, colorants, and the like. The amount of the optional components is at least partially dependent on the nutritional requirements for different life stages of animals.

Carbohydrates can be supplied by any of a variety of sources known by those skilled in the art, including, but not limited to, oat fiber, cellulose, peanut hulls, beet pulp, parboiled rice, corn starch, corn gluten meal, cereal, and sorghum. Grains supplying carbohydrates can include, but are not limited to, wheat, durum, semolina, corn, barley, and rice. In certain embodiments, the carbohydrate component comprises a mixture of one or more carbohydrate sources. Carbohydrates content of foods can be determined by any number of methods known by those of skill in the art.

Generally, carbohydrate percentage can be calculated as nitrogen free extract (“NFE”), which can be calculated as follows: NFE=100%−(moisture %)−(protein %)−(fat %)−(ash %)−(crude fiber %). The amount of carbohydrate, e.g., calculated as NFE, present in the composition may be about 10 to about 90 wt. %, about 10 to about 70 wt. %, about 10 to about 50 wt. %, about 10 to about 40 weight %, about 10 to about 30 wt. %, about 10 to about 20 wt. %; about 20 to about 90 wt. %, about 20 to about 70 wt. %, about 20 to about 50 wt. %, about 20 to about 40 weight %; about 30 to about 90 wt. %, about 30 to about 70 wt. %, about 30 to about 50 wt. %, about 30 to about 40 weight %; about 50 to about 90 wt. %, about 50 to about 70 wt. %; or about 70 to about 90 wt. %, based on the total weight of the pet composition on a dry matter basis.

In certain embodiments, the pet food composition comprises moisture. The moisture may be present at various amounts or concentrations. In one embodiment, moisture may be present in an amount of from about 3 to about 20 wt. %, based on the total weight of the pet food composition. For example, moisture may be present in an amount of about 3 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 10.5 wt. %, about 11 wt. %, about 11.5 wt. %, about 12 wt. %, about 12.5 wt. %, about 13 wt. %, about 13.5 wt. %, about 14 wt. %, about 14.5 wt. %, or about 15 wt. %, based on the total weight of the pet food composition. In another example, moisture may be present in an amount of from about 6% to about 12%, about 9% to about 13%, about 9% to about 11%, or about 9% to about 13%, based on the total weight of the pet food composition. In certain embodiments, moisture is present in an amount of about 5% to about 12%, about 6% to about 11%, or about 7% to about 10.0%, based on the total weight of the pet food composition. In further embodiments, moisture is present in an amount of about 65% to about 85%, about 60% to about 80%, or about 60% to about 75%, based on the total weight of the pet food composition.

The pet food compositions may include one or more ingredients and/or sources of glucose mimetic, carotenoids, and/or arginine and derivatives thereof. Sources of glucose mimetics may comprise glucose anti-metabolites including 2-deoxy-D-glucose, 5-thio-D-glucose, 3-O-methylglucose, anhydrosugars including 1,5-anhydro-D-glucitol, 2,5-anhydro-D-glucitol, and 2,5-anhydro-D-mannitol, mannoheptulose, and/or avocado extract comprising mannoheptulose. Sources of carotenoids may include lutein, astaxanthin, zeaxanthin, bixin, lycopene, and/or beta-carotene. Sources of antioxidant ingredients may comprise tocopherols (vitamin E), vitamin C, vitamin A, plant-derived materials, carotenoids (described above), selenium, and/or CoQ10 (Co-enzyme Q10). In a preferred embodiment, the pet food composition contains high levels of arginine and derivatives thereof. The amount of arginine present in the composition may be about 0.01 to about 10.0 wt. %, about 0.01 to about 5.0 wt. %, about 0.01 to about 2.0 wt. %, about 0.1 to about 10.0 wt. %, about 0.1 to about 5.0 wt. %, about 0.1 to about 2.0 wt. %; about 0.5 to about 5.0 wt. %, about 0.5 to about 2.0 wt. %, about 1.5 to about 5.0 wt. %, about 1.5 to about 2.0 wt. %, about 0.5 wt. %, about 1.0 wt. %, about 1.4 weight %, about 1.44 wt. %, about 1.8 wt. %, or about 2.0 wt. %, based on the total weight of the composition on a dry matter basis. The arginine present in the composition may L-arginine, D-arginine, or a mixture thereof.

The pet food compositions disclosed herein may be wet or dry compositions, and the ingredients can be either incorporated into the food composition and/or on the surface of any composition component, such as, for example, by spraying, agglomerating, dusting, or precipitating on the surface. Additionally, the pet food compositions may be formulated and produced to be in various forms and/or consistencies. For instance, the pet food compositions may, for example, be a dry, moist or semi-moist animal food composition. “Semi-moist” refers to a food composition containing from about 25 to about 35% moisture. “Moist” food refers to a food composition that has a moisture content of about 60 to 90% or greater. “Dry” food refers to a food composition with about 3 to about 12% moisture content and is often manufactured in the form of small bits or kibbles.

The food products may also include components of more than one consistency, for example, soft, chewy meat-like particles or pieces as well as kibble having an outer coating and an inner “core” component. In some embodiments, the pet food compositions may be in the form of a kibble or food kibble. As used herein, the term “kibble” or “food kibble” refers to a particulate pellet, e.g., like a component of feline or canine feeds. In some embodiments, a food kibble has a moisture, or water, content of less than 15% by weight. Food kibbles may range in texture from hard to soft. Food kibbles may range in internal structure from expanded to dense. Food kibbles may be formed by an extrusion process or a baking process. In non-limiting examples, a food kibble may have a uniform internal structure or a varied internal structure. For example, a food kibble may include a core and a coating to form a coated kibble. It should be understood that when the term “kibble” or “food kibble” is used, it can refer to an uncoated kibble or a coated kibble.

In accordance with one aspect of the disclosure, the pet food composition is in a form comprising a core and a coating disposed on the core. In one embodiment, the core comprises an alpha-amino acid (e.g., lysine) and one or more ancient grain (e.g., quinoa and an amaranth), while the coating comprises eggshell membrane.

The pet food composition may comprise a binder, for example, to retain the kibble form and/or to bind the out coating to the core. In certain embodiments the binder includes but is not limited to any of the following or combinations of the following: monosaccharides such as glucose, fructose, mannose, arabinose; di- and trisaccharides such as sucrose, lactose, maltose, trehalose, lactulose; corn and rice syrup solids; dextrins such as corn, wheat, rice and tapioca dextrins; maltodextrins; starches such as rice, wheat, corn, potato, tapioca starches, or these starches modified by chemical modification; alginates, chitosans; gums such as carrageen, and gum arabic; polyols such as glycerol, sorbitol, mannitol, xylitol, erythritol; esters of polyols such as sucrose esters, polyglycol esters, glycerol esters, polyglycerol esters, sorbitan esters; sorbitol; molasses; honey; gelatins; peptides; proteins and modified proteins such as whey liquid, whey powder, whey concentrate, whey isolate, whey protein isolate, high lactose whey by-product, meat broth solids such as chicken broth, chicken broth solids, soy protein, and egg white. In one embodiment, the pet food composition is substantially free of or free of egg white and/or whole egg ingredients.

In certain embodiments, the binder includes but is not limited to a lipid and/or lipid derivative. Lipids can be used in combination with water and/or other binder components. Lipids can include plant fats such as soybean oil, corn oil, rapeseed oil, olive oil, safflower oil, palm oil, coconut oil, palm kernel oil, and partially and fully hydrogenated derivatives thereof; animal fats and partially and fully hydrogenated derivatives thereof; and waxes.

The composition of the present disclosure can additionally comprise other additives in amounts and combinations familiar to one of skill in the art. Such additives should be present in amounts that do not impair the purpose and effect provided by the invention. Examples of additives include substances with a stabilizing effect, organoleptic substances, processing aids, and substances that provide nutritional benefits.

Stabilizing substances may include, by way of example, substances that tend to increase the shelf life of the composition. Other examples of other such additives potentially suitable for inclusion in the compositions of the invention include, for example, preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Additives for coloring, palatability, and nutritional purposes can include colorants, salts (including, but not limited to, sodium chloride, potassium citrate, potassium chloride, and other edible salts), vitamins, minerals, and flavoring. Other additives can include glucosamine, chondroitin sulfate, vegetable extracts, herbal extracts, etc.

The concentration of such additives in the composition typically can be up to about 5% by weight, based on the total weight of the pet food composition on a dry matter basis. In some embodiments, the concentration of such additives (particularly where such additives are primarily nutritional balancing agents, such as vitamins and minerals) is from about 0% to about 2.0% by weight, based on the total weight of the pet food composition on a dry matter basis. In some embodiments, the concentration of such additives (again, particularly where such additives are primarily nutritional balancing agents) is from about 0% to about 1.0% by weight, based on the total weight of the pet food composition on a dry matter basis. Although the list of foregoing additives may be potentially suitable in some embodiments, one or more of the foregoing additives may be excluded from other embodiments of the pet food composition.

The pet food composition may be produced by various methods to achieve the desired pet food composition or desired form for the pet food composition. For example, dry food may be baked or extruded, then cut into individual shaped portions, such as kibbles. In some embodiments, the pet food composition may be prepared in a canned or wet form using conventional food preparation processes known to those of ordinary skill in the art. Typically, ground animal proteinaceous tissues are mixed with the other ingredients, such as cereal grains, suitable carbohydrate sources, fats, oils, and balancing ingredients, including special purpose additives such as vitamin and mineral mixtures, inorganic salts, cellulose, beet pulp and the like, and water in an amount sufficient for processing. The ingredients are mixed in a vessel suitable for heating while blending the components. Heating the mixture is carried out using any suitable manner, for example, direct steam injection or using a vessel fitted with a heat exchanger. Following addition of all of the ingredients of the formulation, the mixture may be heated to a temperature of from 50° F. to 212° F. Although temperatures outside this range can be used, they may be commercially-impractical without the use of other processing aids. When heated to the appropriate temperature, the material will typically be in the form of thick liquid, which is dispensed into cans. A lid is applied and the container is hermetically sealed. The sealed can is then placed in convention equipment designed for sterilization of the contents. Sterilization is usually accomplished by heating to temperatures of greater than 230° C. for an appropriate time depending on the temperature used, the nature of the composition, and related factors. The pet food compositions and food products of the present disclosure can also be added to or combined with food compositions before, during, or after their preparation.

In some embodiments, the food products may be prepared in a dry form using convention processes known to those of ordinary skill in the art. Typically, dry ingredients, including dried animal protein, plant protein, grains and the like are ground and mixed together. Liquid or moist ingredients, including fats, oils water, animal protein, water, and the like are added combined with the dry materials. The specific formulation, order of addition, combination, and methods and equipment used to combine the various ingredients can be selected from those known in the art. For example, in certain embodiments, the resulting mixture is process into kibbles or similar dry pieces, which are formed using an extrusion process in which the mixture of dry and wet ingredients is subjected to mechanical work at high pressure and temperature, forced through small openings or apertures, and cut off into the kibbles, e.g., with a rotating knife. The resulting kibble can be dried and optionally coated with one or more topical coatings comprising, e.g., flavors, fats, oils, powdered ingredients, and the like. Kibbles may also be prepared from dough by baking, rather than extrusion, in which the dough is placed into a mold before dry-heat processing.

In preparing a composition, any ingredient generally may be incorporated into the composition during the processing of the formulation, e.g., during and/or after mixing of the other components of the composition. Distribution of these components into the composition can be accomplished by conventional means. In certain embodiments, ground animal and/or poultry proteinaceous tissues are mixed with other ingredients, including nutritional balancing agents, inorganic salts, and may further include cellulose, beet pulp, bulking agents and the like, along with sufficient water for processing.

In specific embodiments, the compositions and food products are formulated to address specific nutritional differences between species and breeds of animals, as well as one of more of the attributes of the animal. For example, cat foods, for example, are typically formulated based upon the life stage, age, size, weight, body composition, and breed.

In accordance with a first embodiment, provided is a pet food composition comprising:
from about 1 to about 10 wt. % of quinoa;
from about 1 to about 10 wt. % of amaranth; and
from about 0.5 to about 8 wt. % of egg shell membrane, wherein all weight percentages are based on the total weight of the pet food composition on a dry matter basis.

According to a second embodiment, the pet food composition of the first embodiment further comprising from about 0.1 to about 10 wt. % of a fatty acid.

According to a third embodiment, the pet food composition of the first embodiment, wherein the fatty acid comprises a polyunsaturated fatty acid.

According to a fourth embodiment, the pet food composition of the third embodiment, wherein the polyunsaturated fatty acid comprises an omega-3 fatty acid, an omega-6 fatty acid, or a combination of two or more thereof.

According to a fifth embodiment, the pet food composition of the fourth embodiment, wherein polyunsaturated fatty acid comprises an omega-3 fatty acid selected from linolenic acid, stearidonic acid, eicosatetraenoic acid, eicosapentaenoic acid, docosapentaenoic acid, docosahexaenoic acid, and a combination of two or more thereof.

According to a sixth embodiment, the pet food composition of the fourth or fifth embodiment, wherein the omega-3 fatty acid comprises alpha-linolenic acid.

According to a seventh embodiment, the pet food composition according to one of the fourth to the sixth embodiments, wherein the omega-3 fatty acid comprises eicosapentaenoic acid, docosahexaenoic acid, or a combination thereof.

According to an eighth embodiment, the pet food composition according to one of the fourth to seventh embodiments, wherein the polyunsaturated fatty acid comprises an omega-6 fatty acid selected from linolenic acid, calendic acid, eicosadienoic acid, arachidonic acid, docosadienoic acid, adrenic acid, osbond acid, tetracosatetraenoic acid, tetracosapentaenoic acid, and a combination of two or more thereof.

According to a ninth embodiment, the pet food composition according to the fourth or the eighth embodiments, wherein the polyunsaturated fatty acid comprises an omega-6 fatty acid selected from linolenic acid, arachidonic acid, and a combination of two or more thereof.

According to a tenth embodiment, the pet food composition according to the eighth or the ninth embodiments, wherein the pet food composition has a weight ratio of linolenic acid to arachidonic acid of from about 12:1 to about 50:1, preferably about 15:1 to about 40:1, preferably about 18:1 to about 35:1, preferably about 20:1 to about 30:1, preferably about 22:1 to about 28:1, or preferably about 26:1 to about 28:1.

According to an eleventh embodiment, the pet food composition according to one of the fourth to the tenth embodiments, wherein the food composition has a weight ratio of omega-3 fatty acids to omega-6 fatty acids of from about 0.5:1 to about 7:1, preferably, about 0.5:1 to about 3:1, preferably about 0.5:1 to about 2.5:1, preferably about 0.5:1 to about 2:1, preferably about 0.5:1 to about 1.5:1, preferably about 0.5:1 to about 1:1; about 0.6:1 to about 7:1, preferably, about 0.6:1 to about 3:1, preferably about 0.6:1 to about 2.5:1, preferably about 0.6:1 to about 2:1, preferably about 0.6:1 to about 1.5:1, or preferably about 0.6:1 to about 1:1.

According to a twelfth embodiment, the pet food composition according to any preceding embodiment, wherein the pet food composition has a macronutrient value comprising:

from about 9 to 30 wt. % of fat;

from about 10 to about 40 wt. % of protein; and

from about 2 to about 20 wt. % of dietary fiber, the dietary fiber comprising:
i) from about 1 to about 18 wt. % of insoluble fiber, and
ii) from about 0.5 to about 8 wt. % of soluble fiber.

According to a thirteenth embodiment, the pet food composition according to the twelfth embodiment, wherein the food composition has a weight ratio of soluble fiber to insoluble fiber of from about 0.2:1 to about 10:1, preferably about 1:1 to about 10:1, preferably about 1:1 to about 8:1, preferably about 1:1 to about 6:1, preferably about 2:1 to about 6:1, or preferably about 2:1 to about 4:1.

According to a fourteenth embodiment, the pet food composition according to any foregoing embodiment, wherein the pet food composition comprises a core and a coating disposed on the core, the core comprising the lysine, the quinoa, and the amaranth, and the coating comprising the egg shell membrane.

In accordance with a fifteenth embodiment, a pet food composition is provided comprising:

an alpha-amino acid;

one or more ancient grain;

egg shell membrane;

wherein the pet food composition has a macronutrient value comprising:
from about 1 to about 8 wt. % of omega-3 fatty acid; and
from about 1 to about 15 wt. % of omega-6 fatty acid,
wherein the food composition has a weight ratio of omega-3 fatty acids to omega-6 fatty acids of from about 0.5:1 to about 7:1, and all weight percentages are based on the total weight of the pet food composition on a dry matter basis.

According to a sixteenth embodiment, the pet food composition according to the fifteenth embodiment, wherein the alpha-amino acid contains an alpha-carboxylic acid group.

According to a seventeenth embodiment, the pet food composition according to the fifteenth or sixteenth embodiments, wherein the alpha-amino acid comprises lysine.

According to an eighteenth embodiment, the pet food composition according to one of the fifteenth to seventeenth embodiments, wherein the one or more ancient grain is selected from spelt, Khorasan wheat, einkorn, emmer, millet, barley, teff, sorghum, quinoa, amaranth, buckwheat, chia, and a combination of two or more thereof.

According to a nineteenth embodiment, the pet food composition according to the eighteenth embodiment, wherein the one or more ancient grain comprises an amaranth.

According to a twentieth embodiment, the pet food composition according to one of the fifteenth to nineteenth embodiments, wherein pet food composition comprises at least two ancient grains.

According to a twenty first embodiment, the pet food composition according to one of the fifteenth to the twentieth embodiments, wherein the weight ratio of omega-3 fatty acids to omega-6 fatty acids is from about 0.5:1 to about 3:1, preferably about 0.5:1 to about 2.5:1, preferably about 0.5:1 to about 2:1, preferably about 0.5:1 to about 1.5:1, or preferably about 0.5:1 to about 1:1.

According to a twenty second embodiment, the pet food composition according to one of the fifteenth to the twenty first embodiments, wherein the omega-3 fatty acid selected from linolenic acid, stearidonic acid, eicosatetraenoic acid, eicosapentaenoic acid, docosapentaenoic acid, docosahexaenoic acid, and a combination of two or more thereof.

According to a twenty third embodiment, the pet food composition according to one of the fifteenth to the twenty second embodiments, wherein the omega-6 fatty acid selected from linolenic acid, calendic acid, eicosadienoic acid, arachidonic acid, docosadienoic acid, adrenic acid, osbond acid, tetracosatetraenoic acid, tetracosapentaenoic acid, and a combination of two or more thereof.

In accordance with a twenty fourth embodiment, provided is a pet food composition comprising:

(a) a core, the core comprising:
quinoa;
amaranth; and

(b) a coating disposed on the core, the coating comprising:
egg shell membrane,
wherein the pet food composition has a macronutrient value comprising from about 2 to about 10 wt. % of dietary fiber, the dietary fiber comprising:
from about 1 to about 9 wt. % of insoluble fiber, and
from about 0.2 to about 4 wt. % of soluble fiber,
wherein the food composition has a weight ratio of soluble fiber to insoluble fiber of from about 0.2:1 to about 10:1, and all weight percentages are based on the total weight of the pet food composition on a dry matter basis.

According to a twenty fifth embodiment, the pet food composition according to the twenty fourth embodiment, wherein the weight ratio of soluble fiber to insoluble fiber is from about 0.5:1 to about 10:1, preferably about 1:1 to about 8:1, preferably about 1:1 to about 6:1, preferably about 2:1 to about 6:1, or preferably about 2:1 to about 4:1.

According to a twenty sixth embodiment, the pet food composition according to one of the twenty fourth or the twenty fifth embodiments, wherein the macronutrient value of the pet food composition further comprising from about 0.1 to about 10 wt. % of a fatty acid.

According to a twenty seventh embodiment, the pet food composition according to the twenty sixth embodiment, wherein the fatty acid comprises a polyunsaturated fatty acid.

According to a twenty eighth embodiment, the pet food composition according to the twenty seventh embodiment, wherein the polyunsaturated fatty acid comprises an omega-3 fatty acid, an omega-6 fatty acid, or a combination of two or more thereof.

According to a twenty ninth embodiment, the pet food composition according to the twenty eighth embodiment, wherein polyunsaturated fatty acid comprises an omega-3 fatty acid selected from linolenic acid, stearidonic acid, eicosatetraenoic acid, eicosapentaenoic acid, docosapentaenoic acid, docosahexaenoic acid, and a combination of two or more thereof.

According to a thirtieth embodiment, the pet food composition according to the twenty eighth or twenty ninth embodiments, wherein the omega-3 fatty acid comprises alpha-linolenic acid.

According to a thirty first embodiment, the pet food composition according to one of the twenty eighth to thirtieth embodiments, wherein the omega-3 fatty acid comprises eicosapentaenoic acid, docosahexaenoic acid, or a combination thereof.

According to a thirty second embodiment, the pet food composition according to one of the twenty eighth to thirtieth embodiments, the pet food composition of one of the twenty fourth to the twenty sixth embodiments, wherein the polyunsaturated fatty acid comprises an omega-6 fatty acid selected from linolenic acid, calendic acid, eicosadienoic acid, arachidonic acid, docosadienoic acid, adrenic acid, osbond acid, tetracosatetraenoic acid, tetracosapentaenoic acid, and a combination of two or more thereof.

According to a thirty third embodiment, the pet food composition according to the twenty eighth or thirty second embodiments, wherein the polyunsaturated fatty acid comprises an omega-6 fatty acid selected from linolenic acid, arachidonic acid, and a combination of two or more thereof.

According to a thirty fourth embodiment, the pet food composition according to the thirty second or the thirty third embodiments, wherein the pet food composition has a weight ratio of linolenic acid to arachidonic acid of from about 12:1 to about 50:1, preferably about 15:1 to about 40:1, preferably about 18:1 to about 35:1, preferably about 20:1 to about 30:1, or preferably about 22:1 to about 28:1.

According to a thirty fifth embodiment, the pet food composition according to one of the twenty eighth to thirty fourth embodiments, wherein the food composition has a weight ratio of omega-3 fatty acids to omega-6 fatty acids of from about 0.5:1 to about 7:1, preferably, about 0.5:1 to about 3:1, preferably about 0.5:1 to about 2.5:1, preferably about 0.5:1 to about 2:1, preferably about 0.5:1 to about 1.5:1, preferably about 0.5:1 to about 1:1, about 0.6:1 to about 7:1, preferably, about 0.6:1 to about 3:1, preferably about 0.6:1 to about 2.5:1, preferably about 0.6:1 to about 2:1, preferably about 0.6:1 to about 1.5:1, or preferably about 0.6:1 to about 1:1.

According to a thirty sixth embodiment, the pet food composition according to one of the twenty eighth to the thirty fifth embodiments, wherein the food composition further comprising an alpha-amino acid.

According to a thirty seventh embodiment, the pet food composition according to the thirty sixth embodiment, wherein the alpha-amino acid contains an alpha-carboxylic acid group.

According to a thirty eighth embodiment, the pet food composition according to the thirty seventh embodiment, wherein the alpha-amino acid comprises lysine.

According to a thirty ninth embodiment, the pet food composition according to any foregoing embodiment, wherein the pet food composition is in the form of a pet treat and/or a supplement adapted for combination with pet food.

In accordance with a fortieth embodiment, provided is a method for alleviating pruritus, erythema, alopecia, or skin and ear secretion in atopic dermatitis canine, the method comprising:

increasing one or more of long chain polyunsaturated fatty acid, nicotinamide, 1-methylnicotinamide, or a combination of two or more thereof in a canine by feeding the canine a pet food composition of any proceeding claim.

In accordance with a forty first embodiment, provided is a method for alleviating pruritus, erythema, alopecia, or skin and ear secretion in an atopic dermatitis canine, the method comprising:

reducing sphingomyelins, ceramides, to improve skin lipid homeostasis, metabolites and/or acylcarnitines that activate proinflammatory signaling pathways in a canine by feeding the canine a pet food composition of any proceeding claim.

According to a forty second embodiment, the method of the fortieth or the forty first embodiment, wherein the canine is fed the pet food at least once a day, preferably at least twice a day, or preferably at least three times a day.

According to a forty third embodiment, the method of one of the fortieth to the forty second embodiments, wherein the canine is fed the pet food for one or more days, preferably five or more days, preferably 7 or more days, preferably 10 or more days, preferably 14 or more days, preferably 30 or more days, or preferably 42 or more days.

In accordance with a forty fourth embodiment, provided is a pet food composition comprising:

an amount of quinoa;

an amount of amaranth; and

an amount of egg shell membrane,

wherein the pet food composition has a weight ratio of quinoa to amaranth of from about 1:12 to about 12:1, optionally from about 1:10 to about 10:1, optionally from about 1:8 to about 8:1, optionally from about 1:7 to about 7:1, optionally from about 1:6 to about 6:1, optionally from about 1:5 to about 5:1, optionally from about 1:4 to about 4:1, optionally from about 1:3 to about 3:1, or optionally from about 1:2 to about 2:1;

the pet food composition having a weight ratio of quinoa to egg shell membrane of from about 1:10 to about 12:1, optionally from about 1:8 to about 10:1, optionally from about 1:6 to about 8:1, optionally from about 1:5 to about 7:1, optionally from about 1:4 to about 6:1, optionally from about 1:3 to about 5:1, optionally from about 1:2 to about 4:1, optionally from about 1:1 to about 3:1, or optionally from about 1:1 to about 2:1; and

the pet food composition having a weight ratio of amaranth to egg shell membrane of from about 1:10 to about 12:1, optionally from about 1:8 to about 10:1, optionally from about 1:6 to about 8:1, optionally from about 1:5 to about 7:1, optionally from about 1:4 to about 6:1, optionally from about 1:3 to about 5:1, optionally from about 1:2 to about 4:1, optionally from about 1:1 to about 3:1, or optionally from about 1:1 to about 2:1.

According to a forty fifth embodiment, the pet food composition according to the forty fourth embodiment, wherein the pet food composition has a weight ratio of quinoa to amaranth to egg shell membrane (quinoa:amaranth:egg shell membrane) of from about 1:10:8 to about 10:10:1.

According to a forty sixth embodiment, the pet food composition according to the forty fourth or forty fifth embodiment, comprising:

from about 1 to about 10 wt. % of quinoa;

from about 1 to about 10 wt. % of amaranth; and

from about 0.5 to about 8 wt. % of egg shell membrane,

wherein all weight percentages are based on the total weight of the pet food composition on a dry matter basis.

### EXAMPLES

### Example 1

An exemplary food composition (Example Composition A) and a comparative food composition (Comparative Composition 1) were prepared in accordance with aspects of the disclosure. As seen in Table 1, Example Composition A and Comparative Composition 1 were prepared to have similar macronutrient values. Example Composition A was prepared to include 2.5 wt. % of quinoa and 2.5 wt. % of amaranth, based on the total weight of the food composition, while Comparative Composition 1 did not include either quinoa or amaranth, as seen in Table 2.

TABLE 1

| | Ex. A | Comp. 1 |
|---|---|---|
| | (Wt. %) | (Wt. %) |
| Ash | 5.5 | 5.5 |
| Fat Crude | 13.6 | 15.3 |
| Fiber Crude | 2.2 | 2.1 |
| Fiber Insoluble | 7.5 | 8.2 |
| Fiber Neutral Detergent | 3.8 | 4.4 |
| Fiber Soluble | 1.7 | 1.3 |
| Fiber Total Dietary | 9.2 | 9.5 |
| Moisture | 7.4 | 7.4 |
| Protein Crude | 16.9 | 16.6 |
| CHO | 54.3 | 53.2 |

TABLE 2

| | Ex. A | Comp. 1 |
|---|---|---|
| Ingredient | (Wt. %) | (Wt. %) |
| Potato crushed | 34 | 34 |
| Potato starch | 15.6 | 19.7 |
| Potato protein | 10.2 | 10.2 |
| Amaranth G01 | 1-4 | |
| Quinoa Seed | 1-4 | |
| Dicalcium Phosphate | 1.3 | 1.3 |
| Potassium Chloride | 1 | 1 |
| Cellulose Pellet | 1 | 1 |
| Venison Meal | 1 | 1 |
| Sod Chloride | 0.57 | 0.57 |
| Calcium carbonate | 0.44 | 0.44 |
| Choline Chloride, liquid | 0.26 | 0.26 |
| Vitamin premix | 0.22 | 0.22 |
| Methionine, di | 0.18 | 0.18 |
| Taurine | 0.1 | 0.1 |
| Glycerol monostearate | 0.1 | 0.1 |
| Mineral mixture | 0.06 | 0.06 |
| Tryptophan | 0.04 | 0.04 |
| Venison, fresh | 15.6 | 16.6 |
| Lactic acid, liquid | 1.2 | 1.2 |
| Choice white grease | 6.3 | 6.3 |
| (Pork fat) | | |
| Soybean oil | 2.6 | 2.6 |
| Palatant | 2 | 2 |
| Fish oil | 1 | 1 |
| Vitamin E oil | 0.18 | 0.18 |
| (29 wt. %) | | |

### Example 2

To evaluate Example Composition A and Comparative Composition 1, 30 canines were fed either Example Composition A or Comparative Composition 1 for a period of 42 days based on the canines specific metabolic needs. Specifically, 15 canines having dermatological problems were selected along with 15 healthy canines, which were pair-matched by age and gender. All of the canines had an age ranging from 4.6 to 15.10 years and a body weight ranging from 7.1 to 14.5 kg. The selected canines were of mixed gender and were neutered or spayed.

The 30 canines were pre-feed with a maintenance diet for 28 days and then divided into two groups (each group having 15 canines, matched by age, gender, and phenotype (i.e., whether the canine was healthy or had dermatological problems). The first group of 15 canines was fed Example Composition A for 42 days, while the second group of 15 canines was fed Comparative Composition 1. After the 42 days, the first group of 15 canines was fed Comparative Composition 1 for 42 days, while the second group of 15 canines was fed Example Composition A for 42 days. There was no washout period between the first 42 days of feeding and the second period of 42 days of feeding.

Fecal and blood samples for each of the canines were collected at the end of the 28 days of maintenance diet, at the end of the 42 days of receiving the first food composition, and at the end of the second 42 days of receiving the second food composition. Various skin symptoms were assessed by a veterinarian using a prescribed questionnaire at the end of the 28 days of maintenance diet, at the end of the 42 days of receiving the first food composition, and at the end of the second 42 days of receiving the second food composition to determine the severity of alopecia, erythema, ear secretions, and pruritus.

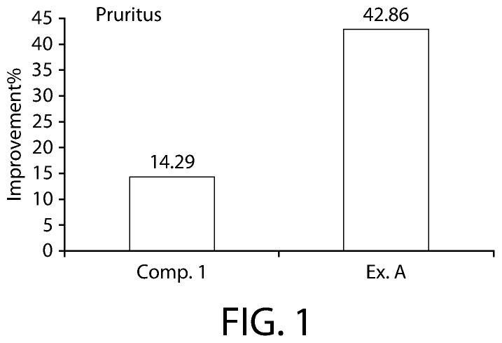

Example Composition A was determined to reduce pruritus symptoms and exhibited a response rate of canines 42.86% greater than Comparative Composition A (see FIG. 1). However, no observable differences were found in the reduction of other symptoms such as alopecia, ear secretions and erythema when canines suffering from dermatological problems were fed Example Composition A as compared to Comparative Composition 1.

Additionally, Example Composition A decreased the mean level of fecal calprotectin in canines suffering from dermatological problems as compared to Comparative Composition 1. In particular, the number of canines that exhibited a decrease in fecal calprotectin levels after receiving the 42 days of Example Composition A was 57.1%. Moreover, while Comparative Composition 1 also provided a reduced mean level of fecal calprotectin in canines, the reduction in calprotectin achieved by Example Composition A was about 55% better than reduction achieved by Comparative Composition 1. Calprotectin is a protein that is abundant in neutrophils (a type of leukocyte) and is released under active inflammatory status at the site of inflammation in the intestine and subsequently increased in the feces. Thus, fecal calprotectin is an important clinical test marker for gastrointestinal tract inflammation and is considered as a non-invasive marker for screening purposes. Calprotectin is also considered a marker for gut barrier membrane permeability, where the fecal calprotectin levels are higher when gut membrane barrier permeability is compromised.

The blood samples for each of the canines was also evaluated to determine a neutrophils count. Based on the data, canines receiving Example Composition A for 42 days had an increase in the mean level of neutrophils count for canines having dermatological problems. Though the neutrophils count increased in the canines having dermatological problems after receiving Example Composition A for 42 days as compared to Comparative Composition 1, the fecal calprotectin levels were decreased, which indicates a reduction of active inflammatory status in the gut.

### Example 3

An exemplary food composition (Example Composition B) and a comparative food composition (Comparative Composition 2) were prepared according to the formulations shown in Table 3. Both Example Composition B and Comparative Composition 2 were in the form of kibble and were produced by a method that included extrusion, drying, and then coating with palatants. Example Composition B and Comparative composition B had similar macronutrient values as seen in Table 4. However, Example Composition B was included 2 wt. % of ESM powder, based on the total weight of the pet food composition on a dry matter basis, while Comparative Composition did not include ESM powder.

TABLE 3

| | Example | Comparative |
|---|---|---|
| | Composition B | Composition 2 |
| | (wt. %) | (wt. %) |
| Potato crushed | 34.3 | 34.3 |
| Potato starch | 19.7 | 19.7 |
| Potato protein | 9.2 | 10.2 |
| Dicalcium phosphate | 1.3 | 1.3 |
| Potassium chloride | 1 | 1 |
| Cellulose pellet | 1 | 1 |
| Venison meal | 1 | 1 |
| Sodium chloride | 0.57 | 0.57 |
| Calcium Carbonate | 0.44 | 0.44 |
| Choline Chloride | 0.26 | 0.26 |
| (70% concentration) | | |
| Vitamin premix | 0.22 | 0.22 |
| Methionone di | 0.18 | 0.18 |
| Gly monostearate | 0.1 | 0.1 |
| Taurine | 0.1 | 0.1 |
| Min Premix 2305 | 0.06 | 0.06 |
| Tryptophan 1 | 0.04 | 0.04 |
| Venison fresh | 15 | 16 |
| Lactic acid, liquid | 1.5 | 1.5 |
| White grease | 6.3 | 6.3 |
| (pork fat) | | |
| Soybean oil | 2.6 | 2.6 |
| Eggshell membrane | 1-3 | |
| Palatant | 2 | 2 |
| Fish oil | 1 | 1 |
| Vitamin E oil | 0.2 | 0.2 |
| (29 wt. % | | |
| concentration) | | |

A summary of the macronutrient values of Example Composition B and Comparative Composition 2 is provided in Table 4, below.

TABLE 4

| | Example | Comparative |
|---|---|---|
| | Composition B | Composition 2 |
| | (wt. %) | (wt. %) |
| Ash | 6.1 | 5.6 |
| Fat, Crude | 15 | 15.8 |
| Fiber, Crude | 2 | 2 |
| Fiber, Insoluble | 5.7 | 4.9 |
| Fiber, Neutral Detergent | 5.2 | 2.5 |
| Fiber, Soluble | 1.1 | 0.8 |
| Fiber, Total Dietary | 6.8 | 5.7 |
| Moisture | 7.5 | 7.7 |
| Protein Crude | 16.2 | 16.7 |
| NFE | 53.3 | 52.2 |

### Example 4

Example Composition B and Comparative Composition 2 were evaluated to assess their ability to reduce pruritus, erythema, skin and ear secretions, and alopecia scores. Specifically, 15 canines with clinically diagnosed dermatological problems as well as 15 healthy canines pair-matched by age and gender were evaluated. All of the canines had ages ranging from 5 to 13.10 years and body weights ranging from 7.3 to 31 kg. All animals were of mixed gender, and were neutered or spayed.

The 30 canines were all pre-fed with an adult maintenance food for 28 days and then separated into two groups with the canines pair-matched between the two groups by age, gender, and phenotype (i.e., suffering from a dermatological problem or being healthy). The first group was fed Example Composition B for 42 days, while the second group was fed Comparative Composition 2 for 42 days. After the 42 days, the first group was fed Comparative Composition 2 and the second group was fed Example Composition B for 42 days. There was no washout period between the first 42 days of feeding and the second 42 days of feeding.

Blood samples were collected for the canines at the end of the pre-feed period of 28 days, at the end of the 42 days of receiving the first food composition, and at the end of the second 42 days of receiving the second food composition. The blood samples were analyzed for blood CBC, serum chemistry, metabolites and cytokines. Dermatological health and symptoms were assessed by a veterinarian at the end of the pre-feed period of 28 days, at the end of the 42 days of receiving the first food composition, and at the end of the second 42 days of receiving the second food composition to determine the severity of alopecia, erythema, ear secretions and pruritus. In order to assess the effect of the pet food compositions, a mixed model analysis was performed using JMP Pro v15.0, with the food treatment (i.e., the 42 days of receiving Example Composition B or Comparative Composition 2) being a fixed effect and the specific canine being a random effect.

Example Composition B reduced pruritus, erythema scores thus increasing the response rate (improvement) of dogs by 7.14% and 7.14% respectively. Comparative Composition 2 reduced pruritus, erythema scores and increased the response rate (improvement) of dogs by 14.29 and 28.57, respectively. The reduction in pruritus and erythema provided by Example Composition B was consistent with lowering levels of WBC count, neutrophils, neutrophils/lymphocytes ratio, albumins and globulins. As seen in Table 5, Example Composition B provided a lower inflammatory state for canines suffering from dermatitis as compared to Comparative Composition 2. In addition, the blood glucose levels were significantly (p<0.05) reduced in the dogs fed Example Composition B as compared with those fed Comparative Composition 2.

TABLE 5

| | Dermatitis dogs | | Healthy dogs | |
|---|---|---|---|---|
| Blood CBC/chemistry | Comp. 2 | Ex. B | Comp. 2 | Ex. B |
| Neutrophils (k/ul) | 4.2 | 3.8 | 4 | 3.6 |
| Lymphocytes (k/ul) | 1.6 | 1.5 | 1.8 | 2 |
| N/L ratio | 2.6 | 2.4 | 2.2 | 1.8 |
| WBC (k/ul) | 6.4 | 5.9 | 6.4 | 6.3 |
| Globulin (g/dL) | 2.3 | 2.2 | 2.3 | 2.3 |
| Albumin (g/dL) | 3.4 | 3.4 | 3.5 | 3.4 |
| Glucose (mg/dL) | 95.1 | 90.7 | 98 | 93.9 |

Additionally, Example Composition B increased the levels of serum metabolites such as 12, 13 DiHOME and 5-oxoproline which induces thermogenesis through brown adipose tissue activation, and also increases metabolic activity to reduce the host inflammatory state in both canines suffering from dermatitis and healthy canines compared with Comparative Composition 2. Similarly, Example Composition B increased the levels of serum metabolites of anti-oxidative stress agents including betaine, ophthalmate, methionine sulfone and methionine sulfoxide (see Table 6) in both canines suffering from dermatitis and healthy canines compared with Comparative Composition 2. Oxidative stress (OS) can cause widespread damage to cells. Specifically, methionine in free and protein bound form are particularly sensitive to oxidation by reactive oxygen species (ROS) resulting in diastereomers of methionine sulfoxide and methionine sulfone mediated by methionine sulfoxide reductase enzyme system that is prevalent in both prokaryotes and eukaryotes. The significant reduction of methionine sulfoxide/methionine ratio by Example Composition B indicates a reduction in oxidative stress by the efficient methionine sulfoxide reductase system compared to control food. Likewise, ophthalmate is produced as a combating mechanism under oxidative stress conditions, specifically during cysteine deficiency where gamma glutamyl synthetase utilizes 2-aminobutyric acid instead of cysteine to produce ophthalmate as an analog of reduced glutathione (GSH). Betaine is known to function physiologically as an osmoprotectant and an anti-inflammatory in numerous diseases. Significant increase of betaine by Example Composition B compared with Comparative Composition 2 in both canines suffering from dermatitis and healthy canines suggests that Example Composition B alleviates oxidative stress and inflammation. Overall, Example Composition B appears to have a multi-factorial effect in alleviating oxidative stress and inflammation in both canines suffering from dermatitis and healthy canines through methionine sulfoxide reductase system, glutathione/ophthalmate reductase system and betaine.

TABLE 6

| | | | | | Overall mixed |
|---|---|---|---|---|---|
| | | | | | model - Food |
| | Dermatitis dogs | | Healthy dogs | | effect |
| Serum metabolites | Comp. 2 | Ex. B | Comp. 2 | Ex. B | (P value) |
| sphingomyelin (d18:1/19:0, | 1.088 | 1.026 | 1.186 | 1.136 | <0.05 |
| d19:1/18:0)* | | | | | |
| sphingomyelin (d18:1/20:1, | 1.046 | 0.956 | 1.182 | 1.164 | <0.05 |
| d18:2/20:0)* | | | | | |
| sphingomyelin (d18:1/21:0, | 1.035 | 0.947 | 1.177 | 1.147 | <0.05 |
| d17:1/22:0, d16:1/23:0)* | | | | | |
| sphingomyelin (d18:1/22:1, | 1.042 | 0.938 | 1.098 | 1.048 | <0.05 |
| d18:2/22:0, d16:1/24:1)* | | | | | |
| sphingomyelin (d18:1/24:1, | 1.024 | 0.966 | 1.102 | 1.076 | <0.05 |
| d18:2/24:0)* | | | | | |
| sphingomyelin (d18:2/14:0, | 1.169 | 1.088 | 1.310 | 1.210 | <0.05 |
| d18:1/14:1)* | | | | | |
| sphingomyelin (d18:2/21:0, | 1.132 | 1.013 | 1.198 | 1.121 | <0.05 |
| d16:2/23:0)* | | | | | |
| sphingomyelin (d18:2/23:0, | 1.069 | 0.968 | 1.217 | 1.172 | <0.05 |
| d18:1/23:1, d17:1/24:1)* | | | | | |
| sphingomyelin (d18:2/23:1)* | 1.117 | 1.005 | 1.259 | 1.187 | <0.05 |
| sphingomyelin (d18:2/24:1, | 0.999 | 0.917 | 1.129 | 1.103 | <0.05 |
| d18:1/24:2)* | | | | | |
| sphingomyelin (d18:2/24:2)* | 1.005 | 0.894 | 1.182 | 1.091 | <0.05 |
| tricosanoyl sphingomyelin | 1.064 | 0.970 | 1.184 | 1.139 | <0.05 |
| (d18:1/23:0)* | | | | | |
| behenoyl | 1.035 | 0.975 | 1.152 | 1.107 | <0.05 |
| dihydrosphingomyelin | | | | | |
| (d18:0/22:0)* | | | | | |
| behenoyl sphingomyelin | 1.035 | 0.963 | 1.131 | 1.100 | <0.05 |
| (d18:1/22:0)* | | | | | |
| hydroxypalmitoyl | 1.047 | 0.942 | 1.105 | 1.051 | <0.05 |
| sphingomyelin | | | | | |
| (d18:1/16:0(OH)) | | | | | |
| lignoceroyl sphingomyelin | 1.000 | 0.933 | 1.132 | 1.083 | <0.05 |
| (d18:1/24:0) | | | | | |
| N-palmitoyl-sphinganine | 1.272 | 1.102 | 1.260 | 1.135 | <0.05 |
| (d18:0/16:0) | | | | | |
| N-palmitoyl-sphingosine | 1.106 | 1.026 | 1.143 | 1.045 | <0.05 |
| (d18:1/16:0) | | | | | |
| glycosyl-N-palmitoyl- | 1.077 | 0.966 | 1.158 | 1.150 | <0.05 |
| sphingosine (d18:1/16:0) | | | | | |
| N-arachidoyl-sphingosine | 1.115 | 1.060 | 1.210 | 1.106 | <0.05 |
| (d18:1/20:0)* | | | | | |
| N-stearoyl-sphingadienine | 1.120 | 1.027 | 1.245 | 1.121 | <0.05 |
| (d18:2/18:0)* | | | | | |
| N-behenoyl-sphingadienine | 1.033 | 0.959 | 1.190 | 1.052 | <0.05 |
| (d18:2/22:0)* | | | | | |
| ceramide (d18:1/17:0, | 1.166 | 1.086 | 1.375 | 1.221 | <0.05 |
| d17:1/18:0)* | | | | | |
| ceramide (d18:2/24:1, | 1.015 | 0.947 | 1.057 | 0.953 | <0.05 |
| d18:1/24:2)* | | | | | |
| ethyl beta-glucopyranoside | 1.614 | 2.263 | 2.082 | 2.990 | <0.05 |
| hydroxystearate sulfate | 1.092 | 2.184 | 1.106 | 2.766 | <0.05 |
| betaine | 0.983 | 1.029 | 0.895 | 0.945 | <0.05 |
| methionine sulfone | 1.126 | 1.251 | 1.153 | 1.283 | <0.05 |
| methionine sulfoxide | 0.994 | 1.008 | 1.026 | 1.037 | <0.05 |
| ophthalmate | 1.235 | 1.653 | 1.315 | 1.587 | <0.05 |
| 12,13-DiHOME | 0.850 | 1.232 | 1.230 | 1.890 | <0.05 |
| 5-oxoproline | 1.021 | 1.079 | 1.019 | 1.034 | 0.07 |
| methionine | 1.013 | 1.080 | 0.988 | 1.094 | 0.45 |
| methionine | 0.981 | 0.934 | 1.038 | 0.947 | <0.05 |
| sulfoxide/methionine | | | | | |

Example Composition B also significantly increased hydroxy stearate and ethyl beta glucopyranoside levels to improve the skin membrane barrier integrity compared with Comparative Composition 2 (see Table 6). Hydroxystearate activates PPARα to improve skin membrane barrier function by normalizing skin sphingolipid rheostat through reducing sphingolipids profile as observed in this study that test food reduced short chain length (<24) sphingomyelins and ceramides compared with control food (see Table 6). Increasing short chain length ceramides and sphingomyelins are playing a role in impaired skin membrane barrier function in atopic dermatitis conditions. In addition, significantly increased levels of ethyl beta glucopyranoside in Example Composition B fed dogs compared with Comparative Composition 2 fed dogs in both canines suffering from dermatitis and healthy canines, which have been shown to improve the skin membrane barrier function by improving dermal fibroblasts proliferation and up regulating collagen type I and type III biosynthesis genes (Table 6). Further, there is a trend of increased cytokines such as IL-2, IL-6 and TNFα in Example Composition B fed dogs (see Table 7) compared with Comparative Composition 2 fed dogs with dermatitis problems but not in healthy dogs. Thus, it is believed that Example Composition B helps improve skin keratinocytes proliferation and movement from basal to upper layer to improve skin membrane barrier function. The increase in cytokine level is not observed in healthy dogs which supports the notion that dogs with dermatological problems (including skin barrier dysfunction) will benefit more from the Example Composition B than dogs without dermatological problems.

TABLE 7

| | | |
|---|---|---|
| Serum | | |
| Cytokines | Dermatitis dogs | Healthy dogs |

| (pg/ml) | Comp. 2 | Ex. B | Comp. 2 | Ex. B |
|---|---|---|---|---|
| IL-2 | 3705.867 | 3984.884 | 86.851 | 76.076 |
| IL-6 | 667.989 | 672.121 | 71.926 | 68.721 |
| TNFalpha | 316.919 | 319.171 | 35.516 | 31.046 |

While the increase in cytokines is hypothesized to improve skin barrier function, there does not appear to be an increase in systemic inflammation with test food, because the NLR, an inflammatory indicator, is reduced with Example Composition B in both healthy and dermatitis dogs when compared to Comparative Composition 2 (see Table 5). This indicates that while levels of some circulating cytokines are increased with Example Composition B, Example Composition B does not lead to a general increase in systemic inflammation; rather it may play a specific, targeted, and beneficial role in improving skin barrier function. Additionally, although Example Composition B reduced pruritus and erythema scores less than Comparative Composition 2, Example Composition B did provide a reduction in pruritus and erythema and provide a more significant improvement in for skin immunity, skin lipid homeostasis and systemic immunity evident by metabolites. Overall, the Example Composition B supports a multifaceted approach to improve skin membrane barrier function and skin immunity through alleviating oxidative stress, inflammation and skin lipid homeostasis.

### Example 5

An exemplary food composition (Example Composition C) and a comparative food composition (Comparative Composition 3) were according to the formulations shown in Table 8. Notably, Example Composition C and Comparative Composition 3 had equivalent protein and fat values. Example Composition C was prepared with 2.5 wt. % of quinoa, 2.5 wt. % of amaranth, and 2.0 wt. % of egg shell membrane (ESM) powder, while Comparative Composition 3 included 9.7 wt. % dried egg, based on the total weight of the respective food compositions. Specifically, Example Composition C was prepared by including the 2.5 wt. % of quinoa and 2.5 wt. % of amaranth at the grain mix stage and including the ESM powder at the coating stage.

Additionally, Example Composition C was formulated to have a weight ratio of soluble fiber to insoluble fiber of 0.28 and a weight ratio of linolenic (C18:3) to arachidonic fatty acids (C20:4) of 26.7 Comparative Composition 3 was formulated to have a weight ratio of soluble fiber to insoluble fiber of 0.04 and a weight ratio of linolenic (C18:3) to arachidonic fatty acids (C20:4) of 10.2.

TABLE 8

| | Example | Comparative |
|---|---|---|
| | Composition C | Composition 3 |
| Ingredients | (Wt. %) | (Wt. %) |
| Rice, Brown | 43 | 47.6 |
| Rice, Brewers | 14 | 15 |
| Egg Dried | | 9.7 |
| Rice Protein, | 10 | 4.9 |
| (80% concentration) | | |
| Soybean Oil | 5.3 | 4.8 |
| Flax Seed, Whole Brown | 5 | 3.2 |
| Palatant | 3 | 3 |
| Beet, Pulp | 1.4 | 2.5 |
| Fish Oil | 3 | 2.3 |
| Coconut Oil | 2 | 1.5 |
| Lactic Acid | 1.2 | 1.2 |
| (84% concentration) | | |
| Dicalcium Phosphate | 1.1 | 1 |
| Potassium Chloride | 1 | 1 |
| Calcium Carbonate | 0.6 | 0.6 |
| Fruit and Vegetable Blend, | 0.5 | 0.5 |
| Silva | | |
| α-Lipoic Acid, | 0.3 | 0.3 |
| (5% concentration) | | |
| Sodium Chloride | 0.4 | 0.3 |
| Vitamin Premix | 0.2 | 0.2 |
| Vitamin E | 0.15 | 0.15 |
| (50% concentration) | | |
| Taurine | 0.14 | 0.14 |
| Choline Chloride | 0.3 | 0.1 |
| (70% concentration) | | |
| Methionine, di | 0.07 | 0.07 |
| Mineral, premix | 0.06 | 0.04 |
| Antioxidant, Verdilox | 0.04 | 0.04 |
| Natural Flavor | 0.03 | 0.03 |
| Lysine, I, hydrochloride | 0.1-0.3 | |
| Quinoa Seed Whole White | 1-4 | |
| Amaranth | 1-4 | |
| Egg shell membrane | 1-3 | |

A summary of the macronutrient values of Example Composition C and Comparative Composition 3 is provided in Table 9, below.

TABLE 9

| | |
|---|---|
| Example | Comparative |
| Composition C | Composition 3 |

| | | | | |
|---|---|---|---|---|
| Ash | 4.5 | wt. % | 4 | wt. % |
| Moisture | 7.3 | wt. % | 8.9 | wt. % |
| Crude Fat | 15.2 | wt. % | 17.3 | wt. % |
| Crude Protein | 18.1 | wt. % | 16.4 | wt. % |
| Crude Fiber | 1.2 | wt. % | 1.1 | wt. % |
| NFE | 53.7 | wt. % | 52.3 | wt. % |
| Total Dietary Fiber | 5.1 | wt. % | 4.9 | wt. % |
| Insoluble Fiber | 4 | wt. % | 4.9 | wt. % |
| Soluble Fiber | 1.1 | wt. % | <0.2 | wt. % |

| | | |
|---|---|---|
| Weight Ratio of Soluble | 0.28 | 0.04 |
| Fiber to Insoluble Fiber | | |

| | | | | |
|---|---|---|---|---|
| Omega-3 fatty acid | 2.6 | wt. % | 1.9 | wt. % |
| Omega-6 fatty acid | 4.1 | wt. % | 4 | wt. % |

| | | |
|---|---|---|
| Weight ratio of Omega-3 | 0.63:1 | 0.46:1 |
| fatty acids to Omega-6 | | |
| fatty acids | | |

| | | | | |
|---|---|---|---|---|
| C18:3 Octadecatrienoic | 1.6 | wt. % | 1.1 | wt. % |
| (Linolenic-all isomers) | | | | |
| C20:4 Arachidonic | 0.06 | wt. % | 0.11 | wt. % |
| (all isomers) | | | | |

| | | |
|---|---|---|
| Weight ratio of C18:3 | 26.7:1 | 10.2:1 |
| Octadecatrienoic to C20:40 | | |
| Arachidonic | | |

### Example 6

Example Composition C and Comparative Composition 3 were evaluated to assess their ability to reduce pruritus, erythema, skin and ear secretions, and alopecia scores. Specifically, 14 canines with clinically diagnosed dermatological problems as well as 16 healthy canines pair-matched by age and gender were evaluated. All of the canines had ages ranging from 4.7 to 14.2 years and body weights ranging from 7.9 to 14.7 kg. All animals were of mixed gender, and were neutered or spayed.

The 30 canines were all pre-fed with an adult maintenance food for 28 days and then separated into two groups with the canines pair-matched between the two groups by age, gender, and phenotype (i.e., suffering from a dermatological problem or being healthy). The first group was fed Example Composition C for 42 days, while the second group was fed Comparative Composition 3 for 42 days. After the 42 days, the first group was fed Comparative Composition 3 and the second group was fed Example Composition C for 42 days. There was no washout period between the first 42 days of feeding and the second 42 days of feeding.

The canines were evaluated by a veterinarian to assess the severity of pruritus, erythema, skin and ear secretions, and alopecia at the end of the pre-feed period of 28 days, at the end of the 42 days of receiving the first food composition, and at the end of the second 42 days of receiving the second food composition. In order to assess the effect of the pet food compositions, a mixed model analysis was performed using IMP Pro v15.0, with the food treatment (i.e., the 42 days of receiving Example Composition C or Comparative Composition 3) being a fixed effect and the specific canine being a random effect. Additionally, the effect size was calculated using Cohen's formula: d=(Test food-Control food)/pooled SD.

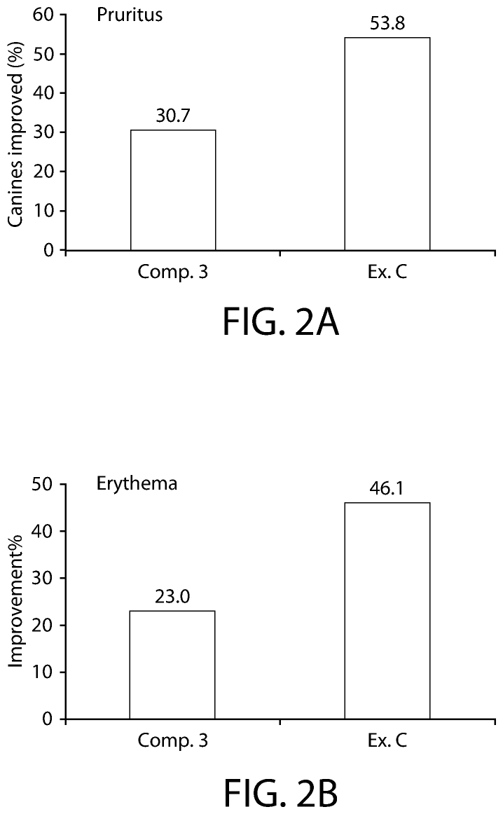

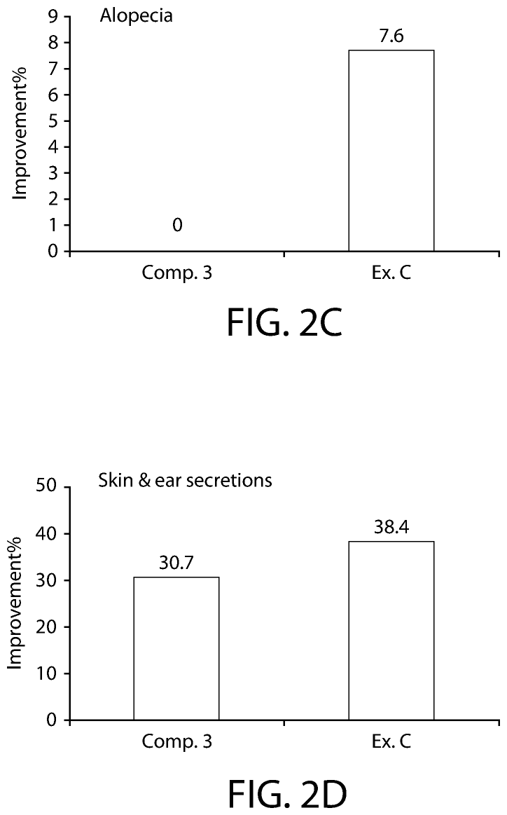

Overall, the canines exhibited a response rate (e.g., exhibited an improvement) of 53.8% for pruritus, 46.1% for erythema, 38.4% for skin and ear secretions, and 7.6% for alopecia. FIGS. 2A-2D are bar graphs showing the response rate of the canines receiving Example Composition C and Comparative Composition 3. In the management of atopic dermatitis condition, the reduction of pruritus and erythema symptoms are considered highly important because the itchiness and redness in the skin can lead to further deterioration if these symptoms persist for an extended period of time. Example Composition C significantly reduced pruritus and erythema when compared to Comparative Composition 3, which indicates that Example Composition C can significantly improves the quality of life for the canine by reducing scratching and other behavior problems associated with chronic pruritus.

Additionally, Example Composition C decreased the mean level of fecal calprotectin in canines as compared with Comparative Composition C. As noted above, fecal calprotectin is an important clinical test marker for gastrointestinal tract inflammation and is considered as a non-invasive marker for screening purposes. Calprotectin is also considered a marker for gut barrier membrane permeability, where the fecal calprotectin levels are higher when gut membrane barrier permeability is compromised.

Similar to calprotectin impacts, Example Composition C decreased the mean level of fecal alpha-1 antitrypsin inhibitor levels, which is a marker for protein losing enteropathy and intestinal inflammation. Fecal alpha 1-proteinase inhibitor is a serum protease inhibitor resistant to intestinal protein degradation and excretion in the feces. In the presence of intestinal inflammation and compromised gut membrane barrier permeability, alpha-1 proteinase inhibitor excretion generally increases in a canine's feces. Overall, Example Composition C decreased the levels of fecal calprotectin and alpha-1 proteinase inhibitor, indicating an improvement in gut immunity.

Further, it was determined that Example Composition C decreased the mean levels of serum IgE (48.80 ug/ml) compared with the Comparative Composition 3 (61.58 ug/ml), as seen in Table 10, below. Serum IgE levels are positively correlated with increased allergic responses, specifically airborne allergens in atopic dermatitis in atopic dogs.

TABLE 10

| | Overall | | | | |
|---|---|---|---|---|---|
| | model (Food | | | | |
| | effect) | | | | Cohen |
| | FDR Adj | Mean | | Pooled | effect |
| Analytes | PValue | Comp. 3 | Ex. C | SD | size |
| IgE (ug/mL) | 0.669 | 61.585 | 48.807 | 63.038 | −0.203 |
| Cholesterol | <0.0001 | 226.555 | 199.296 | 44.989 | −0.606 |
| (mg/dL) | | | | | |
| Methionine | <0.0001 | 0.075 | 0.251 | 0.281 | 0.629 |
| sulfone | | | | | |
| 12,13-DiHOME | 0.026 | −0.214 | 0.072 | 0.468 | 0.612 |

Example Composition C also significantly decreased the levels of cholesterol compared with Comparative Composition 3. Without being particularly limited to any specific theory, it is believed that total cholesterol levels and triglycerides may be useful for predicting the onset of atopic dermatitis. Example Composition C increased the levels of serum metabolite ‘12,13 DiHOME,’ a metabolite of the linolenic acid pathway, when compared with Comparative Composition 3. 12, 13 DiHOME is believed to induce thermogenesis through brown adipose tissue activation, and also increase the uptake of circulating fatty acids into the brown tissue thus reducing serum levels of triglycerides. Increased circulating levels of triglycerides can increase vascular inflammation.

Similarly, the Example Composition C increased the levels of serum metabolite methionine sulfone, an anti-oxidative stress agent compared with Comparative Composition 3. Oxidative stress (OS) can cause widespread damage to cells. Specifically, methionine in free and protein bound forms is particularly sensitive to oxidation by reactive oxygen species (ROS). The resultant diastereomers of methionine sulfoxide and methionine sulfone are mediated by the methionine sulfoxide reductase enzyme system that is prevalent in both prokaryotes and eukaryotes.

Example Composition C also yielded a decrease in circulating acylcarnitines levels in the canine as compared with Comparative Composition 3 (see Table 11, below). Acylcarnitines are the products of incomplete beta-oxidation of fatty acids, which have the potential to activate proinflammatory signaling pathways.

TABLE 11

| | | Overall model | | | | Cohen |
|---|---|---|---|---|---|---|
| | | (Food effect) | Mean | | Pooled | size |
| SUB_PATHWAY | Chemical | FDR Adj PValue | Comp. 3 | Ex. C | SD | effect |
| Acyl Carnitine, | octadecanedioylcarnitine | 0.34 | 0.023 | −0.061 | 0.297 | −0.281 |
| Dicarboxylate | (C18-DC)* | | | | | |
| | adipoylcarnitine (C6-DC) | 0.74 | −0.061 | −0.013 | 0.541 | 0.088 |
| | octadecenedioylcarnitine | 0.77 | −0.529 | −0.470 | 0.565 | 0.105 |
| | (C18:1-DC)* | | | | | |
| Acyl Carnitine, | 3-hydroxydecanoylcarnitine | 0.24 | −0.290 | −0.657 | 0.944 | −0.388 |
| Hydroxy | 3-hydroxyoleoylcarnitine | 0.5 | 0.063 | −0.066 | 0.667 | −0.194 |
| | (S)-3- | 0.64 | 0.119 | 0.070 | 0.396 | −0.123 |
| | hydroxybutyrylcarnitine | | | | | |
| | 3-hydroxyoctanoylcarnitine | 0.89 | −0.018 | −0.045 | 0.381 | −0.073 |
| | (1) | | | | | |
| | 3-hydroxyoctanoylcarnitine | 0.9 | −0.077 | −0.117 | 0.436 | −0.091 |
| | (2) | | | | | |
| Acyl Carnitine, | stearoylcarnitine (C18) | <0.0001 | 0.155 | −0.129 | 0.349 | −0.814 |
| Long Chain | behenoylcarnitine (C22)* | 0.002 | 0.078 | −0.164 | 0.436 | −0.555 |
| Saturated | palmitoylcarnitine (C16) | 0.006 | 0.033 | −0.158 | 0.290 | −0.659 |
| | cerotoylcarnitine (C26)* | 0.01 | 0.070 | −0.046 | 0.352 | −0.329 |
| | lignoceroylcarnitine (C24)* | 0.07 | 0.077 | −0.071 | 0.398 | −0.372 |
| | arachidoylcarnitine (C20)* | 0.09 | −0.165 | −0.444 | 0.623 | −0.449 |
| | margaroylcarnitine (C17)* | 0.2 | 0.043 | −0.125 | 0.451 | −0.371 |
| | myristoylcarnitine (C14) | 0.79 | 0.179 | 0.139 | 0.407 | −0.099 |
| Acyl Carnitine, | cis-3,4- | <0.0001 | 0.062 | 0.265 | 0.278 | 0.732 |
| Medium Chain | methyleneheptanoylcarnitine | | | | | |
| | decanoylcarnitine (C10) | 0.24 | 0.084 | −0.048 | 0.462 | −0.286 |
| | laurylcarnitine (C12) | 0.5 | 0.130 | 0.041 | 0.468 | −0.191 |
| | hexanoylcarnitine (C6) | 0.96 | 0.068 | 0.053 | 0.388 | −0.040 |
| | octanoylcarnitine (C8) | 0.98 | 0.044 | 0.042 | 0.440 | −0.003 |
| Acyl Carnitine, | eicosenoylcarnitine | <0.0001 | 0.019 | −0.249 | 0.328 | −0.819 |
| Monounsaturated | (C20:1)* | | | | | |
| | oleoylcarnitine (C18:1) | 0.009 | 0.050 | −0.154 | 0.335 | −0.609 |
| | myristoleoylcarnitine | 0.22 | 0.089 | −0.076 | 0.556 | −0.297 |
| | (C14:1)* | | | | | |
| | undecenoylcarnitine (C11:1) | 0.41 | 0.179 | 0.077 | 0.414 | −0.248 |
| | 5-dodecenoylcarnitine | 0.41 | 0.084 | −0.040 | 0.572 | −0.216 |
| | (C12:1) | | | | | |
| | 3-decenoylcarnitine | 0.5 | −0.216 | −0.460 | 0.787 | −0.310 |
| | cis-4-decenoylcarnitine | 0.5 | −0.182 | −0.296 | 0.612 | −0.186 |
| | (C10:1) | | | | | |
| | ximenoylcarnitine (C26:1)* | 0.56 | −0.100 | −0.245 | 0.561 | −0.260 |
| | butenoylcarnitine (C4:1) | 0.62 | 0.004 | −0.094 | 0.479 | −0.205 |
| | palmitoleoylcarnitine | 0.98 | 0.082 | 0.081 | 0.295 | −0.003 |
| | (C16:1)* | | | | | |
| Acyl Carnitine, | arachidonoylcarnitine | 0.001 | −0.762 | −1.136 | 0.369 | −1.012 |
| Polyunsaturated | (C20:4) | | | | | |
| | dihomo-linoleoylcarnitine | 0.04 | −0.051 | −0.196 | 0.289 | −0.503 |
| | (C20:2)* | | | | | |
| | linolenoylcarnitine (C18:3)* | 0.22 | 0.034 | 0.136 | 0.294 | 0.347 |
| | dihomo-linolenoylcarnitine | 0.22 | −0.224 | −0.383 | 0.446 | −0.356 |
| | (C20:3n3 or 6)* | | | | | |
| | linoleoylcarnitine (C18:2)* | 0.32 | 0.041 | −0.045 | 0.304 | −0.282 |
| Acyl Carnitine, | acetylcarnitine (C2) | 0.21 | 0.073 | −0.014 | 0.346 | −0.252 |
| Short Chain | | | | | | |

Example Composition C also showed an increasing trend of circulating long chain polyunsaturated fatty acids (PUFAs), such as eicosapentaenoic acid (EPA) and docosahexaenoic acid DHA, which are anti-inflammatory and antioxidant, and is also believed to attenuate food allergy. Conversely, Example Composition C reduced the levels of circulating arachidonic acid, which has potential to produce proinflammatory cytokines through the lipoxygenase pathway, as seen in Table 12 (below).

TABLE 12

| | Overall | | | | |
|---|---|---|---|---|---|
| | model_Food | | | | |
| | effect | | | | Cohen |
| | FDR Adj | Mean | | Poole | effect |
| Long chain PUFAs | PValue | Comp. 3 | Ex. C | dSD | size |
| eicosapentaenoate (EPA; 20:5n3) | <0.0001 | 0.195 | 0.685 | 0.544 | 0.900 |
| heneicosapentaenoate (21:5n3) | 0.004 | −0.033 | 0.284 | 0.644 | 0.493 |
| stearidonate (18:4n3) | 0.005 | 0.283 | 0.588 | 0.546 | 0.558 |
| heptadecatrienoate (17:3)* | 0.011 | 0.120 | 0.419 | 0.553 | 0.541 |
| hexadecatrienoate (16:3n3) | 0.018 | 0.283 | 0.584 | 0.617 | 0.488 |
| linolenate [alpha or gamma; | 0.022 | 0.074 | 0.386 | 0.598 | 0.522 |
| (18:3n3 or 6)] | | | | | |
| docosapentaenoate | 0.119 | −0.055 | 0.132 | 0.554 | 0.337 |
| (n3 DPA; 22:5n3) | | | | | |
| hexadecadienoate (16:2n6) | 0.147 | 0.116 | 0.281 | 0.476 | 0.345 |
| docosahexaenoate (DHA; 22:6n3) | 0.266 | 0.219 | 0.308 | 0.416 | 0.214 |
| linoleate (18:2n6) | 0.622 | −0.054 | −0.004 | 0.343 | 0.145 |
| dihomo-linoleate (20:2n6) | 0.841 | 0.040 | 0.060 | 0.432 | 0.046 |
| tetradecadienoate (14:2)* | 0.851 | 0.107 | 0.121 | 0.509 | 0.028 |
| docosadienoate (22:2n6) | 0.841 | 0.022 | −0.008 | 0.369 | −0.080 |
| arachidonate (20:4n6) | <0.0001 | 0.008 | −0.242 | 0.355 | −0.703 |
| adrenate (22:4n6) | 0.337 | −0.098 | −0.189 | 0.281 | −0.325 |
| dihomo-linolenate (20:3n3 or n6) | 0.896 | 0.062 | 0.049 | 0.387 | −0.032 |

Example Composition C increased the nicotinamide adenine dinucleotide (NAD) metabolism in the canines. Also, canines receiving Example Composition C exhibited an increase in circulating nicotinamide and 1-methylnicotinamide levels compared with canines receiving the Comparative Composition 3 (see Table 13, below). Nicotinamide and 1-methylnicotinamide as believed to exhibit anti-inflammatory effect. Further, nicotinamide is believed to enhance the extracellular matrix and skin barrier by inducing the expression of skin fibrous components (e.g., collagen and elastin). Example Composition B also reduced short chain length (e.g., <24 atoms) sphingomyelins and ceramides compared with Comparative Composition B (see Tables 9 and 10, above). Increasing short chain length sphingomyelins and ceramides may play a role in impaired skin membrane barrier function in AD.

TABLE 13

| | Overall | | | | |
|---|---|---|---|---|---|
| | model (Food | | | | |
| | effect) | | | | Cohen |
| | FDR Adj | Mean | | Pooled | effect |
| NAD pathway metabolites | PValue | Comp. 3 | Ex. C | SD | size |
| trigonelline (N′- | <0.0001 | −0.422 | 0.142 | 0.360 | 1.566 |
| methylnicotinate) | | | | | |
| nicotinamide N-oxide | <0.0001 | 0.075 | 0.416 | 0.477 | 0.715 |
| 1-methylnicotinamide | <0.0001 | 0.042 | 0.256 | 0.304 | 0.701 |
| nicotinamide | <0.0001 | 0.100 | 0.412 | 0.530 | 0.589 |
| N1-Methyl-2-pyridone-5- | 0.002 | 0.076 | 0.293 | 0.458 | 0.473 |
| carboxamide | | | | | |
| nicotinamide riboside | 0.430 | −0.593 | −0.392 | 0.669 | 0.300 |
| quinolinate | 0.422 | 0.144 | 0.191 | 0.553 | 0.086 |

TABLE 14

| | Overall | | | | |
|---|---|---|---|---|---|
| | model_Food | | | | |
| | effect | | | | Cohen |
| | FDR Adj | Mean | | Pooled | effect |
| Sphingomyelins | PValue | Comp. 3 | Ex. C | SD | size |
| sphingomyelin (d18:2/18:1)* | 0.000 | −0.022 | −0.347 | 0.177 | −1.833 |
| sphingomyelin (d18:1/18:1, | 0.000 | −0.049 | −0.299 | 0.227 | −1.102 |
| d18:2/18:0) | | | | | |
| palmitoyl sphingomyelin (d18:1/16:0) | 0.000 | −0.027 | −0.188 | 0.152 | −1.061 |
| stearoyl sphingomyelin (d18:1/18:0) | 0.000 | 0.065 | −0.097 | 0.154 | −1.054 |
| sphingomyelin (d18:1/17:0, | 0.000 | 0.039 | −0.137 | 0.200 | −0.885 |
| d17:1/18:0, d19:1/16:0) | | | | | |
| sphingomyelin (d18:2/16:0, | 0.000 | −0.079 | −0.253 | 0.250 | −0.695 |
| d18:1/16:1)* | | | | | |
| tricosanoyl sphingomyelin | 0.001 | 0.025 | −0.124 | 0.279 | −0.532 |
| (d18:1/23:0)* | | | | | |
| behenoyl sphingomyelin | 0.000 | 0.048 | −0.032 | 0.206 | −0.385 |
| (d18:1/22:0)* | | | | | |
| sphingomyelin (d18:1/24:1, | 0.001 | 0.076 | 0.005 | 0.201 | −0.356 |
| d18:2/24:0)* | | | | | |
| lignoceroyl sphingomyelin | 0.001 | 0.059 | −0.019 | 0.222 | −0.351 |
| (d18:1/24:0) | | | | | |
| sphingomyelin (d17:1/16:0, | 0.027 | −0.009 | −0.080 | 0.239 | −0.296 |
| d18:1/15:0, d16:1/17:0)* | | | | | |
| sphingomyelin (d18:1/19:0, | 0.069 | 0.083 | 0.022 | 0.264 | −0.230 |
| d19:1/18:0)* | | | | | |
| sphingomyelin (d17:2/16:0, | 0.201 | −0.066 | −0.163 | 0.470 | −0.205 |
| d18:2/15:0)* | | | | | |
| sphingomyelin (d18:2/23:0, | 0.155 | 0.011 | −0.044 | 0.343 | −0.160 |
| d18:1/23:1, d17:1/24:1)* | | | | | |
| sphingomyelin (d18:1/20:0, | 0.525 | 0.062 | 0.036 | 0.171 | −0.147 |
| d16:1/22:0)* | | | | | |
| sphingomyelin (d18:2/24:1, | 0.553 | 0.074 | 0.056 | 0.241 | −0.073 |
| d18:1/24:2)* | | | | | |
| sphingomyelin (d18:1/25:0, | 0.731 | 0.027 | −0.002 | 0.437 | −0.067 |
| d19:0/24:1, d20:1/23:0, d19:1/24:0)* | | | | | |
| sphingomyelin (d18:1/20:2, | 0.954 | −0.410 | −0.425 | 0.542 | −0.028 |
| d18:2/20:1, d16:1/22:2)* | | | | | |

TABLE 15

| | Overall | | | | |
|---|---|---|---|---|---|
| | model (Food | | | | |
| | effect) | | | | Cohen |
| | FDR Adj | Mean | | Pooled | effect |
| Ceramides | PValue | Comp. 3 | Ex. C | SD | size |
| N-stearoyl-sphingosine | 0.000 | −0.010 | −0.414 | 0.346 | −1.166 |
| (d18:1/18:0)* | | | | | |
| N-stearoyl-sphingadienine | 0.005 | −0.156 | −0.648 | 0.638 | −0.770 |
| (d18:2/18:0)* | | | | | |
| ceramide (d18:1/17:0, | 0.000 | 0.009 | −0.303 | 0.431 | −0.724 |
| d17:1/18:0)* | | | | | |
| N-palmitoyl-sphingosine | 0.134 | 0.007 | −0.105 | 0.267 | −0.421 |
| (d18:1/16:0) | | | | | |
| N-arachidoyl-sphingosine | 0.019 | 0.082 | −0.017 | 0.262 | −0.376 |
| (d18:1/20:0)* | | | | | |
| N-palmitoyl-sphingadienine | 0.662 | 0.008 | −0.069 | 0.458 | −0.169 |
| (d18:2/16:0)* | | | | | |
| N-behenoyl-sphingadienine | 0.860 | −0.059 | −0.086 | 0.454 | −0.061 |
| (d18:2/22:0)* | | | | | |
| N-stearoyl-sphinganine | 0.000 | 0.059 | −0.791 | 0.881 | −0.966 |
| (d18:0/18:0)* | | | | | |
| N-palmitoyl-sphinganine | 0.004 | 0.082 | −0.161 | 0.372 | −0.654 |
| (d18:0/16:0) | | | | | |
| sphingomyelin (d18:0/18:0, | 0.000 | 0.073 | −0.358 | 0.365 | −1.183 |
| d19:0/17:0)* | | | | | |
| palmitoyl dihydrosphingomyelin | 0.000 | 0.059 | −0.106 | 0.178 | −0.923 |
| (d18:0/16:0)* | | | | | |
| behenoyl dihydrosphingomyelin | 0.000 | 0.088 | −0.093 | 0.239 | −0.758 |
| (d18:0/22:0)* | | | | | |
| sphingomyelin (d18:0/20:0, | 0.000 | 0.122 | 0.000 | 0.240 | −0.507 |
| d16:0/22:0)* | | | | | |
| glycosyl-N-stearoyl-sphingosine | 0.000 | 0.063 | −0.169 | 0.268 | −0.865 |
| (d18:1/18:0) | | | | | |
| glycosyl-N-palmitoyl-sphingosine | 0.001 | 0.085 | −0.048 | 0.248 | −0.536 |
| (d18:1/16:0) | | | | | |
| glycosyl ceramide (d18:1/20:0, | 0.001 | 0.101 | −0.045 | 0.280 | −0.518 |
| d16:1/22:0)* | | | | | |
| glycosyl-N-(2- | 0.119 | 0.042 | −0.059 | 0.421 | −0.240 |
| hydroxynervonoyl)-sphingosine | | | | | |
| (d18:1/24:1(2OH))* | | | | | |
| glycosyl ceramide (d18:2/24:1, | 0.167 | 0.024 | −0.079 | 0.484 | −0.212 |
| d18:1/24:2)* | | | | | |
| lactosyl-N-stearoyl-sphingosine | 0.000 | 0.089 | −0.099 | 0.192 | −0.978 |
| (d18:1/18:0)* | | | | | |
| lactosyl-N-palmitoyl-sphingosine | 0.016 | 0.052 | −0.018 | 0.271 | −0.254 |
| (d18:1/16:0) | | | | | |
| lactosyl-N-behenoyl-sphingosine | 0.405 | 0.050 | −0.010 | 0.394 | −0.152 |
| (d18:1/22:0)* | | | | | |

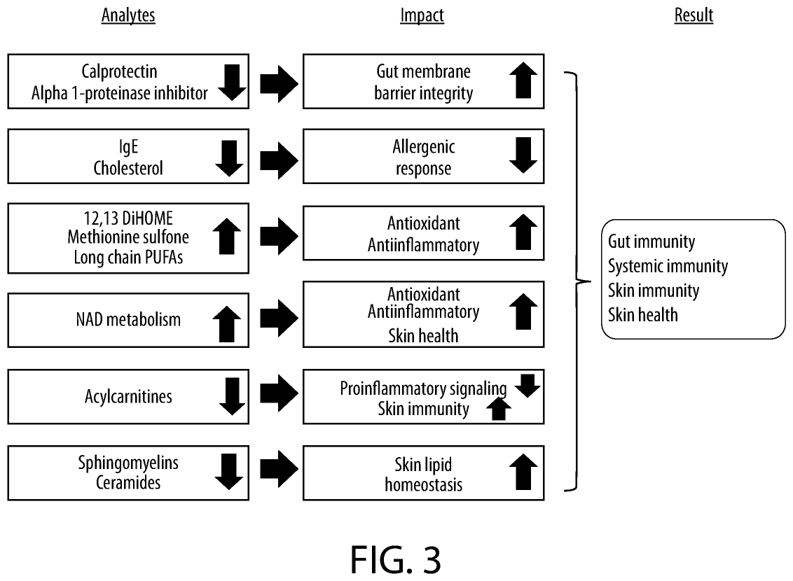

In sum, Example Composition C provided a multifaceted benefit to improve gut immunity, systemic immunity, skin immunity and skin health through alleviating oxidative stress and proinflammatory signaling pathways and promoting anti-inflammatory status and skin lipid homeostasis to alleviate canine atopic dermatitis. FIG. 3 is a schematic showing a summary of the multifaceted benefits simultaneously achieved by Example Composition C.

What is claimed is:

1-46. (canceled)

47. A pet food composition comprising:
from about 1 to about 10 wt. % of quinoa;
from about 1 to about 10 wt. % of amaranth; and
from about 0.5 to about 8 wt. % of egg shell membrane,
wherein all weight percentages are based on the total weight of the pet food composition on a dry matter basis.

48. The pet food composition of claim 47 further comprising:
from about 0.1 to about 10 wt. % of a fatty acid comprising a polyunsaturated fatty acid.

49. The pet food composition of claim 48, wherein the polyunsaturated fatty acid comprises an omega-3 fatty acid, an omega-6 fatty acid, or a combination of two or more thereof.

50. The pet food composition of claim 49, wherein polyunsaturated fatty acid comprises an omega-3 fatty acid selected from linolenic acid, stearidonic acid, eicosatetraenoic acid, eicosapentaenoic acid, docosapentaenoic acid, docosahexaenoic acid, and a combination of two or more thereof.

51. The pet food composition of claim 49, wherein the omega-3 fatty acid comprises alpha-linolenic acid.

52. The pet food composition of claim 49, wherein the polyunsaturated fatty acid comprises an omega-6 fatty acid selected from linolenic acid, calendic acid, eicosadienoic acid, arachidonic acid, docosadienoic acid, adrenic acid, osbond acid, tetracosatetraenoic acid, tetracosapentaenoic acid, and a combination of two or more thereof.

53. The pet food composition of claim 52, wherein the polyunsaturated fatty acid comprises an omega-6 fatty acid selected from linolenic acid, arachidonic acid, and a combination of two or more thereof.

54. The pet food composition of claim 53, wherein the pet food composition has a weight ratio of linolenic acid to arachidonic acid of from about 12:1 to about 50:1.

55. The pet food composition of claim 49, wherein the food composition has a weight ratio of omega-3 fatty acids to omega-6 fatty acids of from about 0.5:1 to about 7:1.

56. The pet food composition of claim 47, wherein the pet food composition has a macronutrient value comprising:
from about 9 to 30 wt. % of fat;
from about 10 to about 40 wt. % of protein; and
from about 2 to about 20 wt. % of dietary fiber, the dietary fiber comprising:
i) from about 1 to about 18 wt. % of insoluble fiber, and
ii) from about 0.5 to about 8 wt. % of soluble fiber.

57. The pet food composition of claim 56, wherein the food composition has a weight ratio of soluble fiber to insoluble fiber of from about 0.2:1 to about 10:1.

58. The pet food composition of claim 47, wherein the pet food composition comprises a core and a coating disposed on the core, the core comprising the lysine, the quinoa, and the amaranth, and the coating comprising the egg shell membrane.

59. A pet food composition comprising:
(a) a core, the core comprising:
quinoa, and
amaranth; and
(b) a coating disposed on the core, the coating comprising:
egg shell membrane,
wherein the pet food composition has a macronutrient value comprising from about 2 to about 10 wt. % of dietary fiber, the dietary fiber comprising:
from about 1 to about 9 wt. % of insoluble fiber, and
from about 0.2 to about 4 wt. % of soluble fiber,
wherein the food composition has a weight ratio of soluble fiber to insoluble fiber of from about 0.2:1 to about 10:1, and all weight percentages are based on the total weight of the pet food composition on a dry matter basis.

60. The pet food composition of claim 59, wherein the pet food composition has a weight ratio of quinoa to amaranth of from about 1:12 to about 12:1, the pet food composition having a weight ratio of quinoa to egg shell membrane of from about 1:10 to about 12:1, and the pet food composition having a weight ratio of amaranth to egg shell membrane of from about 1:10 to about 12:1.

61. The pet food composition of claim 59, wherein the pet food composition has a weight ratio of quinoa to amaranth to egg shell membrane (quinoa:amaranth:egg shell membrane) of from about 1:10:8 to about 10:10:1.

62. A pet food composition comprising:
an alpha-amino acid;
one or more ancient grain;
egg shell membrane;
wherein the pet food composition has a macronutrient value comprising:
from about 1 to about 8 wt. % of omega-3 fatty acid; and
from about 1 to about 15 wt. % of omega-6 fatty acid,
wherein the food composition has a weight ratio of omega-3 fatty acids to omega-6 fatty acids of from about 0.5:1 to about 7:1, and all weight percentages are based on the total weight of the pet food composition on a dry matter basis.

63. The pet food composition of claim 62, wherein the alpha-amino acid comprises lysine.

64. The pet food composition of claim 62, wherein the pet food composition comprises at least two ancient grains.

65. The pet food composition of claim 62, wherein the omega-3 fatty acid is selected from linolenic acid, stearidonic acid, eicosatetraenoic acid, eicosapentaenoic acid, docosapentaenoic acid, docosahexaenoic acid, and a combination of two or more thereof, and the omega-6 fatty acid is selected from linolenic acid, calendic acid, eicosadienoic acid, arachidonic acid, docosadienoic acid, adrenic acid, osbond acid, tetracosatetraenoic acid, tetracosapentaenoic acid, and a combination of two or more thereof.

66. A method for alleviating pruritus, erythema, alopecia, or skin and ear secretion in atopic dermatitis canine, the method comprising:
increasing one or more of long chain polyunsaturated fatty acid, nicotinamide, 1-methylnicotinamide, or a combination of two or more thereof in a canine by feeding the canine a pet food composition of claim 62.
